(19) United States
(12) Patent Application Publication
(10) Pub. No.: US 2011/0052826 A1
(43) Pub. Date: Mar. 3, 2011

(54) APPLICATION DEVICE AND DRIVING METHOD THEREOF

(75) Inventor: Satoru SHIMODA, Tokyo (JP)

(73) Assignee: Casio Computer Co., Ltd., Tokyo (JP)

(21) Appl. No.: 12/859,300

(22) Filed: Aug. 19, 2010

(30) Foreign Application Priority Data
Aug. 28, 2009 (JP) 2009-197696

(51) Int. Cl. B05D 1/02; B05C 5/00

(52) U.S. Cl. 427/424; 118/663

(57) ABSTRACT

An application device wherein a liquid is applied to an application target region of a substrate disposed on a supporting table by moving a discharge section including a nozzle hole which discharges the liquid in a first direction relative to the supporting table; a displacement amount of the discharge section in a second direction which crosses the first direction is detected while the discharge section moves relative to the supporting table in the first direction; and one of the discharge section and the supporting table is moved in an offset direction which offsets the displacement amount while the discharge section is moved relative to the supporting table in the first direction, so as to control the displacement.

### BACKGROUND OF THE INVENTION

(1) Field of the Invention

The present invention relates to an application device and a driving method thereof.

(2) Description of the Related Art

Conventionally, there is known a nozzle printing method by which an electroluminescence (EL) material-containing liquid is applied to grooves by continuously pouring the EL material-containing liquid into the grooves through a nozzle, each of the grooves being located between partition walls which are formed to enclose a transparent electrode (anode) provided on a glass substrate, at an EL material-containing layer forming step of a manufacturing process of an EL element used for an EL panel. This application method is, for example, disclosed in Japanese Patent Application Laid-open Publication No. 2002-75640.

In this case, the EL material-containing layer is formed by drying the applied EL material-containing liquid, and The EL element is manufactured by disposing a counter electrode (cathode) on the formed EL material-containing layer. An application target region to which the EL material-containing liquid is applied is a light-emitting region of the EL panel.

However, in the case disclosed in the above-mentioned document, the nozzle which discharges the EL material-containing liquid is provided with a holding member which moves along a guiding member. Therefore, when the guiding member is distorted, a vibration occurs at the time of movement of the holding member. As a result, the nozzle may slip out of a position for the application target region provided in each of the grooves between the partition walls, for example. When the EL material-containing liquid is applied to the application target region from the nozzle whose position is not appropriate for the application target region, the EL material-containing liquid may be applied to the outside of the application target region, and/or the thickness of the applied EL material-containing liquid may become uneven. As a result, the EL material-containing layer may be poorly formed. These problems are caused not only by the nozzle printing method but also by an ink-jet method by which application is performed by intermittently discharging liquid drops.

### SUMMARY OF THE INVENTION

The present invention has an advantageous effect of providing an application device and a driving method thereof, the application device which can appropriately apply a liquid to an application target region on a substrate, and which can prevent a liquid-applied film from being poorly formed.

To obtain the advantageous effect mentioned above, a first aspect of the present invention is an application device to apply a liquid on an application target region of a substrate, the application device comprising: at least one discharge section including a nozzle hole which discharges the liquid; a supporting table on which the substrate is disposed; a carrying section to move the discharge section relative to the supporting table in a first direction; a displacement amount detection section to detect a displacement amount of the discharge section in a second direction which crosses the first direction while the discharge section is moved relative to the supporting table in the first direction by the carrying section; a position adjustment section to move one of the discharge section and the supporting table relative to the other in the second direction; and a control section to control the position adjustment section so as to move the one of the discharge section and the supporting table in an offset direction which offsets the displacement amount while the discharge section is moved relative to the supporting table in the first direction by the carrying section.

To obtain the advantageous effect mentioned above, a second aspect of the present invention is a driving method of an application device to apply a liquid on an application target region of a substrate, the driving method comprising the steps of: disposing the substrate on a supporting table; moving at least one discharge section relative to the supporting table in a first direction, the discharge section including a nozzle hole which discharges the liquid; detecting a displacement amount of the discharge section in a second direction which crosses the first direction while moving the discharge section relative to the supporting table in the first direction; and moving one of the discharge section and the supporting table relative to the other in an offset direction which offsets the displacement amount while moving the discharge section relative to the supporting table in the first direction.

### BRIEF DESCRIPTION OF THE DRAWINGS

The present invention will be fully understood by its detailed description below and appended drawings. However, the detailed description and the drawings are given by way of explanation for the present invention only, and thus are not intended to limit the scope of the present invention, wherein

FIG. 1 is a schematic view showing an application device according to a first embodiment of the present invention;

FIGS. 2A and 2B schematically show application operation performed by the application device according to the first embodiment of the present invention;

FIG. 3 is a sectional view showing a nozzle head of the application device according to the first embodiment of the present invention;

FIG. 4 is a sectional view showing a structure of a degassing section at a standby position of the application device according to the first embodiment of the present invention;

FIGS. 5A and 5B show the nozzle head and a position adjustment section of the application device according to the first embodiment of the present invention;

FIG. 6 is an explanatory diagram showing operation of the position adjustment section of the application device according to the first embodiment of the present invention;

FIG. 7 is a diagram illustrating the operation of the position adjustment section of the application device according to the first embodiment of the present invention;

FIG. 8 is an explanatory diagram showing a pattern of application of a liquid, the application performed by moving the nozzle head of the application device according to the first embodiment of the present invention;

FIG. 9 is a schematic view showing the application device according to a second embodiment of the present invention;

FIG. 10A is a diagram illustrating detection of a distortion of a bank by an image pickup section of the application device according to the second embodiment of the present invention;

FIGs. 10B to 10F show different setting positions of the image pickup section of the application device according to the second embodiment of the present invention, respectively;

FIG. 11 is a plane view showing an arrangement of pixels of an EL panel;

FIG. 12 is a plane view showing a schematic structure of the EL panel;

FIG. 13 is a circuit diagram showing a circuit for one pixel of the EL panel;

FIG. 14 is a plane view showing one pixel of the EL panel;

FIG. 15 is a sectional view taken from the line XV-XV in FIG. 14 and viewed along the arrows in FIG. 14;

FIG. 16 is a sectional view showing a pixel electrode exposed between banks of the EL panel;

FIG. 17 is a frontal view showing an example of a cell phone which employs the EL panel as a display panel;

FIGS. 18A and 18B are perspective views showing an example of a digital camera from the front and the back, respectively, the digital camera which employs the EL panel as a display panel; and

FIG. 19 is a perspective view showing an example of a personal computer which employs the EL panel as a display panel.

### DETAILED DESCRIPTION OF THE PREFERRED EMBODIMENTS

Hereinafter, preferred embodiments to implement the present invention are described referring to the drawings. Various limitations are attached to the following embodiments, the limitations which are technically preferred to implement the present invention. However, the following embodiments, to which the limitations are attached, and the drawings are not intended to limit the scope of the present invention.

An application device is used for forming, for example, an organic layer (a hole injection layer, a light-emitting layer, an electron injection layer, or the like) of an organic electroluminescence display panel which is a light-emitting panel; an organic layer of an organic transistor; an organic color developing layer (a color developing layer including an organic material for developing a color of red, green, or blue, a black matrix including an organic material, or the like) of a color filter of a liquid crystal display; an organic electrically-conductive layer (an electrically-conductive wire including an organic material, or the like) of each of various electronic devices; and other organic layers, or a functional layer including an inorganic material such as metal particles which are dispersed or dissolved in a liquid.

In each of the following embodiments, a case where the present invention is applied to an application device which uses the nozzle printing method is described. However, the present invention is not limited thereto. For example, the present invention can be appropriately applied to an application device which uses the ink-jet method by which application is performed by intermittently discharging liquid drops.

### First Embodiment

### (1) Structure of Application Device According to First Embodiment

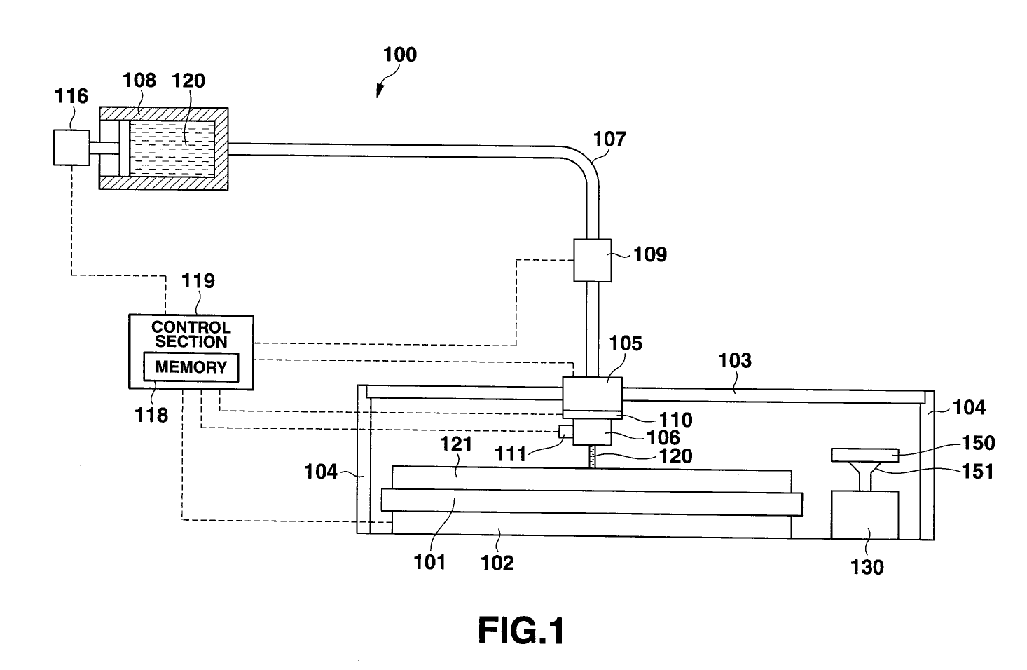

FIG. 1 is a schematic view showing an application device according to a first embodiment of the present invention.

As shown in FIG. 1, an application device 100 includes the following elements a to j.

a. a liquid tank 108 to store a liquid 120;

b. a nozzle head (discharge section) 106 including a nozzle which discharges the liquid 120;

c. a supply pipe 107 which is laid from the liquid tank 108 to the nozzle head 106;

d. a supply device 116 to supply the liquid 120 stored in the liquid tank 108 to the nozzle head 106 through the supply pipe 107;

e. a worktable 101 as a supporting table of which a substrate 121, a target of application of the liquid 120, is disposed on the top surface;

f. a carriage 105 as a nozzle carrying section (carrying section) by which the nozzle head 106 is moved in a prescribed moving direction (first direction) relative to the substrate 121 disposed on the worktable 101;

g. a moving device 102 to move the worktable 101 in a direction (second direction) which crosses the moving direction of the nozzle head 106;

h. a displacement amount detection section 111 to detect the amount of displacement (which may be referred to as a displacement amount hereinafter) of the nozzle head 106 in the second direction, the displacement which occurs while the nozzle head 106 is moved in the first direction;

i. a position adjustment section 110 to adjust a position of the nozzle head 106 relative to the substrate 121 by moving the nozzle head 106 in the second direction; and

j. a control section 119 to control each section and the like of the application device 100.

The moving direction (first direction) of the nozzle head 106 is referred to as a main-scanning direction.

As shown in FIG. 1, the worktable 101 is disposed on the moving device 102, and the substrate 121 is disposed on the worktable 101.

The moving device 102 moves the worktable 101 and the substrate 121 disposed thereon in a linear direction. The moving device 102 includes a rail to guide the worktable 101, and a drive mechanism to drive the worktable 101 along the rail, for example.

The moving device 102 is controlled by the control section 119. The control section 119 intermittently drives the moving device 102, and the moving device 102 intermittently moves the worktable 101 and the substrate 121. That is, the moving device 102 repeats a stop-start movement of the worktable 101 and the substrate 121 by the control of the control section 119.

The moving direction of the worktable 101 is referred to as a sub-scanning direction.

Above the worktable 101, a rail 103 as a guiding section of the carrying section is provided, the rail 103 being supported by a machine casing 104. The rail 103 is disposed in a direction which is the orthogonal direction to the moving direction of the worktable 101 viewed from above. The rail 103 is equipped with the carriage 105, and the carriage 105 is equipped with the nozzle head 106. The carriage 105 and the nozzle head 106 are guided along the rail 103 so as to be movable along the rail 103.

The carriage 105 reciprocates the nozzle head 106 in the main-scanning direction within a parallel plane to the top surface of the worktable 101, the main-scanning direction which is the orthogonal direction to the moving direction of the worktable 101. For example, the carriage 105 includes a built-in driving source such as a built-in motor, and the carriage 105 is driven by the built-in motor and moves along the rail 103.

The carriage 105 is controlled by the control section 119. The control section 119 drives the carriage 105 when the moving device 102 stops, which happens intermittently, and the carriage 105 moves while the moving device 102 stops.

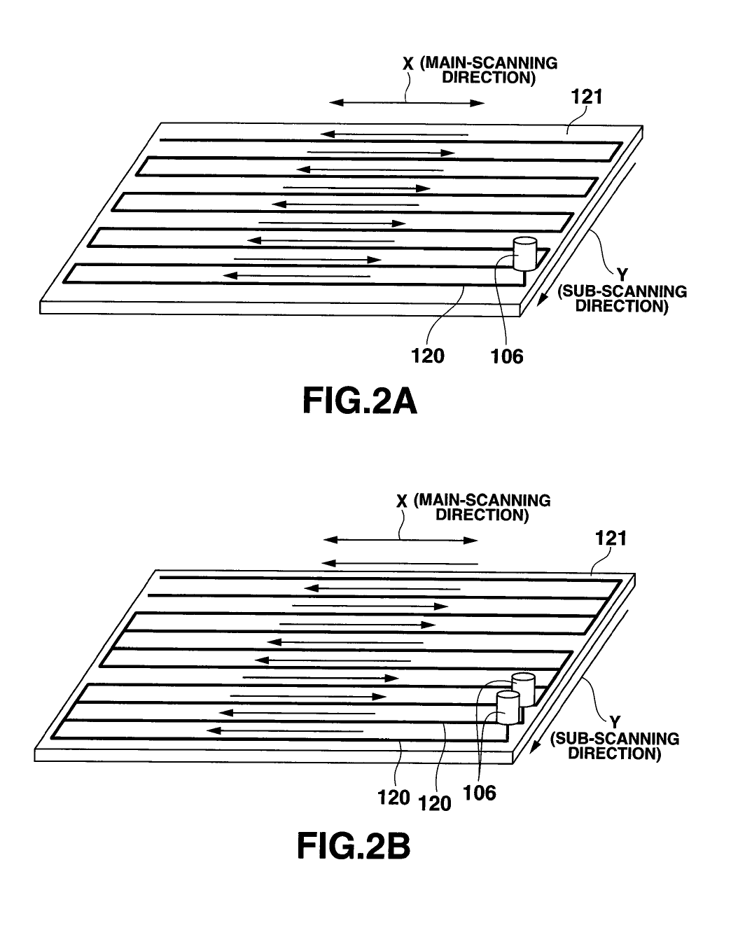

Here, the outline of application operation performed by the application device according to the embodiment of the present invention is described. FIGS. 2A and 2B schematically show application operation performed by the application device 100 according to the first embodiment of the present invention. The X direction and the Y direction shown in FIGS. 2A and 2B are the first direction and the second direction mentioned above, respectively.

As shown in FIG. 2A, the application device 100 applies the liquid 120 onto the substrate 121 by moving the nozzle head 106 in the X direction and the Y direction relative to the substrate 121 by the carriage 105 and the moving device 102 while discharging the liquid 120 from the nozzle of the nozzle head 106. The application device 100 which performs the application operation shown in FIG. 2A includes only one nozzle head 106, and the application operation is performed one line by one line thereby. However, the application device 100 is not limited to having only one nozzle head 106, and may include two or more nozzle heads 106. In such a case, the application is performed on a plurality of lines at the same time. The number of the lines corresponds to the number of the nozzle heads 106.

FIG. 2B schematically shows application operation performed by the application device 100 which includes two nozzle heads 106 and performs the application on two lines at the same time thereby. In this case, the two nozzle heads 106 are equipped with the carriage 105 such that the two nozzle heads 106 are disposed parallel to each other along the Y direction. The two nozzle heads 106 move at the same time. The application operation shown in FIG. 2B is the same as the application operation shown in FIG. 2A, except that a moving amount of the substrate 121 in the Y direction, the substrate 121 moved by the moving device 102, doubles as compared with the case shown in FIG. 2A.

When a plurality of nozzle heads 106 is equipped with the carriage 105, the supply pipe 107, the liquid tank 108, and a massflow controller 109 are provided with each of the plurality of nozzle heads 106.

In the following, the case where the application device 100 includes one nozzle head 106 is described.

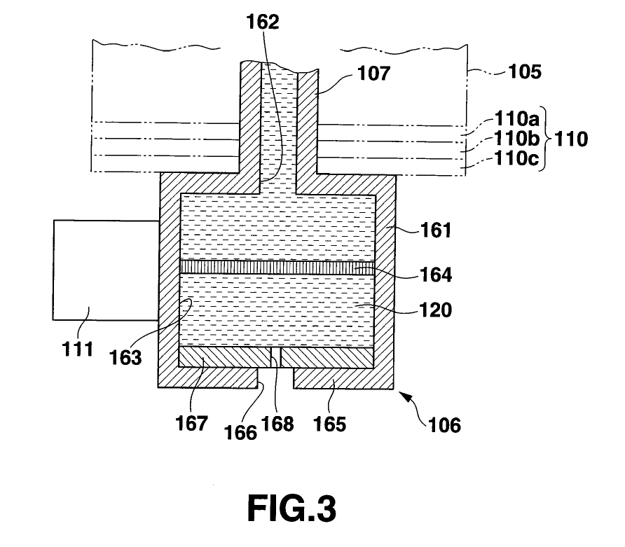

FIG. 3 is a sectional view showing a nozzle head of the application device according to the first embodiment of the present invention.

The nozzle head 106 is equipped with the carriage 105 such that the tip of the nozzle head 106 looks down.

As shown in FIG. 3, the supply pipe 107 is connected to an inlet 162 provided at the upper end of a near-cylindrical nozzle-head main body section 161 of the nozzle head 106. A base 165 is provided at the lower end of the nozzle-head main body section 161, and an opening 166 is formed at the center of the base 165.

A space 163 where the liquid 120 is stored is formed in the nozzle-head main body section 161. A nozzle plate 167 is provided under the space 163, and the opening 166 is blockaded by the nozzle plate 167. A microscopic nozzle hole (nozzle) 168 is formed at a position which is at the near-center of the nozzle plate 167 and corresponds to the opening 166. The diameter of the nozzle hole 168 is 10 μm to 20 μm, for example. The liquid 120 is discharged from the nozzle hole 168.

A filter 164 to remove particles in a liquid is provided at the near-middle in the nozzle-head main body section 161. The space 163 is divided into two spaces, namely, an inlet 162-side space and an opening 166-side space, by the filter 164.

A displacement amount detection section 111 is, for example, a force sensor, a gyroscope, or the like, which uses a piezoelectric element. The displacement amount detection section 111 detects a displacement amount of the nozzle head 106 in the sub-scanning direction (for example, a Y-axis direction or the second direction) which is the orthogonal direction to the main-scanning direction (for example, an X-axis direction or the first direction) while the nozzle head 106 moves along the rail 103 in the main-scanning direction.

The displacement amount detection section 111 is disposed on a side surface of the nozzle head 106, for example. The displacement amount detection section 111 detects the amount of displacement of the nozzle head 106 in the sub-scanning direction, which is the orthogonal direction to the main-scanning direction, based on the displacement of the nozzle head 106, when the nozzle head 106 moves along the rail 103 in the main-scanning direction, and slips in the sub-scanning direction.

It is desired that the nozzle head 106 move linearly along the rail 103. However, when the rail 103 is distorted, for example, by having bumpiness, the carriage 105 may move with a squeak and/or a clatter depending on the distortion peculiar to the rail 103.

The displacement amount detection section 111 is structured to detect the amount of displacement of the nozzle head 106 based on the displacement of the nozzle head 106, the displacement which occurs following a vibration of the nozzle head 106 when the squeak and/or the clatter of the carriage 105 is conveyed to the nozzle head 106 and vibrates the nozzle head 106 accordingly. The displacement amount detection section 111 is controlled by the control section 119.

The nozzle head 106 is equipped with the carriage 105 with the position adjustment section 110 in between. As shown in FIG. 3, the position adjustment section 110 includes, for example, a top surface section 110a which is fixed to the carriage 105, a bottom surface section 110c on which the nozzle head 106 is set up, and a stretch section 110b which relatively moves the top surface section 110a and the bottom surface section 110c in the sub-scanning direction.

The position adjustment section 110 is, for example, a precision linear stage, a piezo stage, an electrostatic stage, or the like. When a prescribed driving signal is input, the stretch section 110b is stretched in a horizontal direction (Y-axis direction) which is the orthogonal direction to the main-scanning direction (X-axis direction). As a result, the position adjustment section 110 moves the nozzle head 106 provided with the bottom surface section 110c in the sub-scanning direction (Y-axis direction) which is the orthogonal direction to the main-scanning direction (X-axis direction). Then, the position adjustment section 110 adjusts a position of the nozzle head 106 relative to the substrate 121 by moving the nozzle head 106 in the sub-scanning direction while the nozzle head 106 is moved in the main-scanning direction by the carriage 105.

The position adjustment section 110 moves the nozzle head 106 relative to the substrate 121 based on a displacement amount of the nozzle head 106, the displacement amount which is detected by the displacement amount detection section 111, in an offset direction which offsets the displacement amount of the nozzle head 106.

The position adjustment section 110 is controlled by the control section 119.

The supply pipe 107 is laid from the nozzle head 106 to the liquid tank 108. One end of the supply pipe 107 is connected to the nozzle head 106, and the other end of the supply pipe 107 is connected to the liquid tank 108.

As the supply pipe 107, a tube composed of a material having resistance properties to the liquid 120 stored in the liquid tank 108 is used. More specifically, the supply pipe 107 is a tube composed of, for example, silicone resin. The inside diameter of the supply pipe 107 is 1 mm to 7 mm. The supply pipe 107 may be equal or unequal in inside diameter for the whole length thereof which is laid from the nozzle head 106 to the liquid tank 108. For example, the inside diameter of the supply pipe 107 may be larger (for example, about 7 mm) at a part which is closer to the liquid tank 108 of the supply pipe 107, and be smaller (for example, about 1 mm) at a part which is closer to the nozzle head 106 of the supply pipe 107.

The liquid 120 is stored in the liquid tank 108. The liquid 120 is, for example, an organic liquid, an aqueous liquid, an emulsion liquid, or the like. The liquid 120 is appropriately selected depending on a use of the application device 100.

The liquid tank 108 is provided with the supply device 116. The supply device 116 supplies the liquid 120 stored in the liquid tank 108 to the nozzle head 106 through the supply pipe 107. The supply device 116 preferably pumps the liquid 120 into the supply pipe 107 in a state where the pressure of the liquid 120 to be supplied to the nozzle head 106 is kept uniform.

The supply device 116 is, for example, a pump, or more specifically, a piston-type pressure pump or a gas-type pressure pump. The piston-type pressure pump pushes out the liquid 120 stored in the liquid tank 108 to the supply pipe 107 by a movable piston being pressed by a driving source such as a motor, an air cylinder, or a solenoid, the movable piston which is housed in the syringe-type liquid tank 108. The gas-type pressure pump pushes out the liquid 120 stored in the liquid tank 108 to the supply pipe 107 by supplying a gas (mainly an inert gas such as a nitrogen gas) into the well-closed liquid tank 108 and applying pressure to the surface of the liquid 120 in the liquid tank 108. A pump other than the piston-type pressure pump and the gas-type pressure pump may be used as the supply device 116.

The supply device 116 is controlled by the control section 119. The control section 119 drives the supply device 116 when the carriage 105 starts to move, and the supply device 116 performs the operation for supplying the liquid 120 while the carriage 105 moves.

The massflow controller 109 is provided at a halfway section of the supply pipe 107. The massflow controller 109 measures and controls a flow rate of the liquid 120 which flows in the supply pipe 107. The flow rate thereof measured by the massflow controller 109 is output to the control section 119.

The control section 119 determines a value of the flow rate thereof which is set by the massflow controller 109. (The value of the flow rate which is set is referred to as a set flow rate hereinafter.) The massflow controller 109 performs a constant flow control such that a value of the flow rate of the liquid 120 which flows in the supply pipe 107 is kept at the set flow rate.

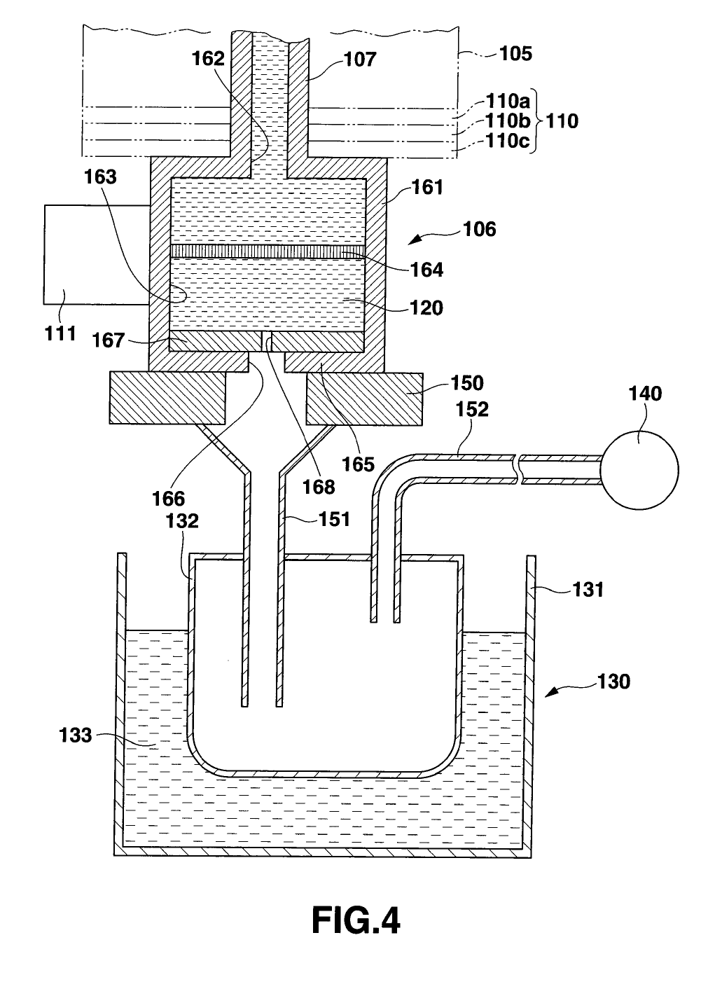

FIG. 4 is a sectional view showing a structure of a degassing section at a standby position of the application device according to the first embodiment of the present invention.

The standby position of the nozzle head 106 is set in the vicinity of the worktable 101 and below the rail 103. An airtight cap 150 is provided at the standby position as the degassing section.

As shown in FIG. 4, one end of a drainpipe 151 is connected to the airtight cap 150. The nozzle hole 168 of the nozzle head 106 is led to the drainpipe 151 by the airtight cap 150 closely contacting with the lower end of the nozzle head 106. The other end of the drainpipe 151 is connected to a cold trap 130.

The cold trap 130 includes: an outer container 131; a refrigerant 133 disposed in the outer container 131; and an airtight container 132 housed in the outer container 131 such that the airtight container 132 is soaked in the refrigerant 133. The other end of the drainpipe 151 passes through the top surface of the airtight container 132. One end of a suction pipe 152 is connected to a vacuum pump (pressure reducing device) 140, and the other end of the suction pipe 152 passes through the top surface of the airtight container 132. In the airtight container 132, the other end of the suction pipe 152 is disposed at a position higher than a position of the other end of the drainpipe 151.

When the nozzle head 106 is in a standby state where the nozzle head 106 does not apply the liquid 120 to the substrate 121, or when air bubbles left in the nozzle head 106 are removed, the nozzle head 106 is moved to the airtight cap 150 by the carriage 105 so as to be connected to the airtight cap 150.

The liquid 120 in the liquid tank 108 can be pulled toward the nozzle head 106, and the liquid 120 discharged from the nozzle head 106 can be caught by the cold trap 130, by the vacuum pump 140 being operated to perform suction in a state where the airtight cap 150 and the lower end of the nozzle head 106 are in close contact with each other. Also, the air bubbles left in the nozzle head 106 can be sucked out and removed by the vacuum pump 140 performing suction.

Next, offset processing to offset a displacement amount of the nozzle head 106 relative to the substrate 121 is described. The offset processing is performed by moving the nozzle head 106 by the position adjustment section 110 in accordance with the displacement amount of the nozzle lead 106 in the sub-scanning direction, the displacement amount detected by the displacement amount detection section 111.

It is preferable that the nozzle head 106 move linearly in the main-scanning direction along the rail 103, and apply the liquid 120 by discharging the liquid 120 at the near-center of an application target region in the width direction thereof which is the orthogonal direction to the main-scanning direction, the application target region to which the liquid 120 is applied on the substrate 121. However, the carriage 105 may move with a squeak and/or a clatter depending on a distortion peculiar to the rail 103. Displacement of the nozzle head 106 in the sub-scanning direction may occur when the squeak and/or the clatter of the carriage 105 is conveyed to the nozzle head 106 and vibrates the nozzle head 106 accordingly.

When the displacement of the nozzle head 106 in the sub-scanning direction occurs at the time of applying the liquid 120 to the substrate 121 by moving the nozzle head 106 in the main-scanning direction, the amount of the liquid 120 applied to the application target region may be unequal in the width direction of the application target region, or the liquid 120 may be applied to a part which is not the application target region because of the nozzle head 106 slipping out of a position corresponding to the application target region.

It is necessary to offset a displacement amount of the nozzle head 106 relative to the substrate 121 in order to prevent such a trouble and to appropriately apply the liquid 120.

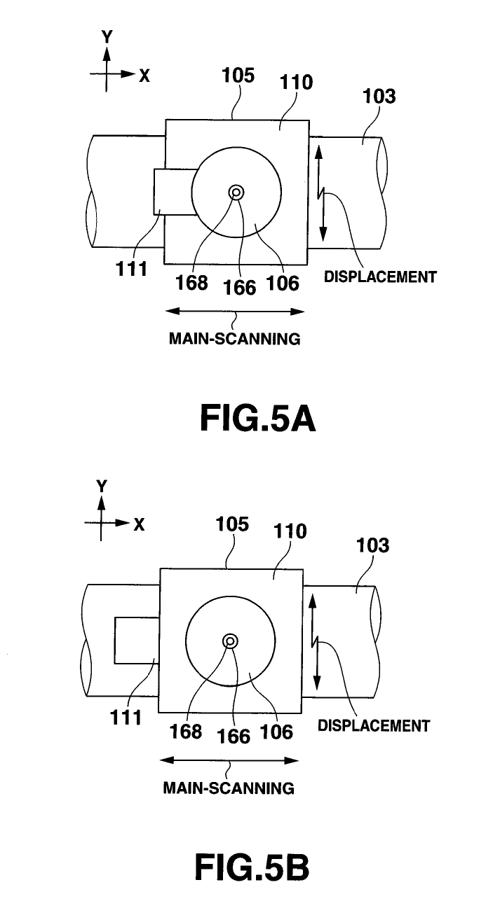

FIGs. 5A and 5B show the nozzle head and a position adjustment section of the application device according to the first embodiment of the present invention.

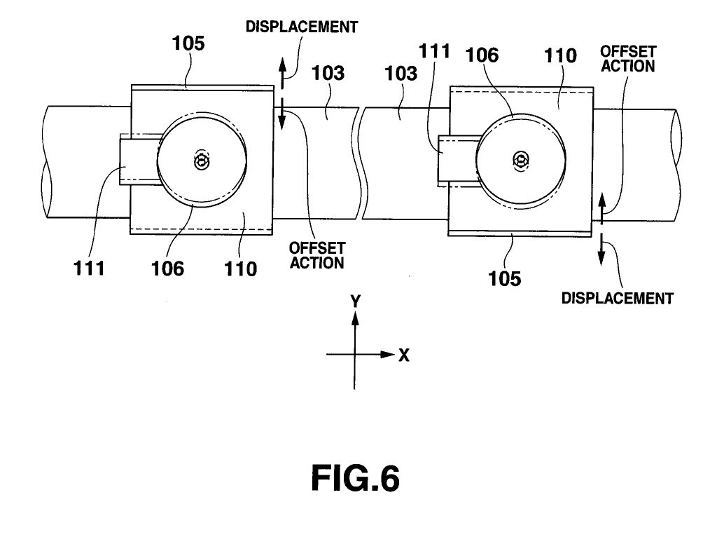

FIG. 6 is an explanatory diagram showing operation of the position adjustment section of the application device according to the first embodiment of the present invention.

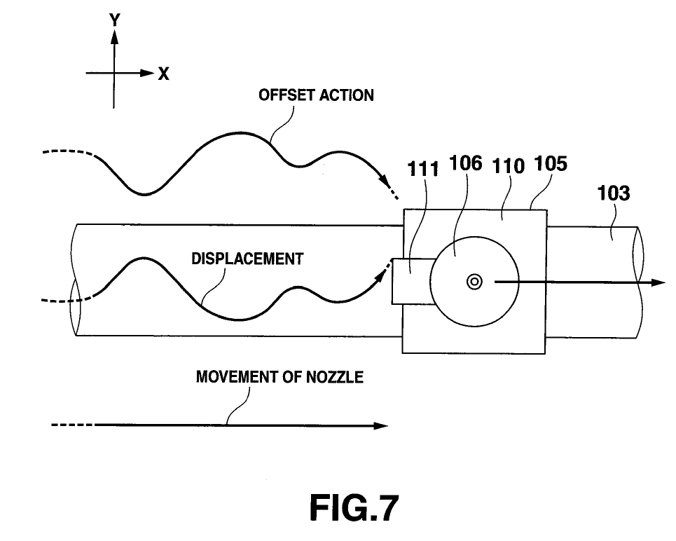

FIG. 7 is a diagram illustrating the operation of the position adjustment section of the application device according to the first embodiment of the present invention.

The displacement amount detection section 111 described above converts vibration intensity corresponding to the detected displacement amount of the nozzle head 106 into the electric signal of a displacement amount signal, and outputs the displacement amount signal which indicates the magnitude (distance) and the direction of the detected displacement amount to the control section 119.

FIGs. 5A and 5B show the nozzle head 106 and the position adjustment section 110 viewed from above the nozzle hole 168 of the nozzle plate 167 of the nozzle head 106. The displacement amount detection section 111 is, for example, equipped with the nozzle head 106 as shown in FIG. 5A. While the displacement amount detection section 111 moves the carriage 105 in the X-axis direction along the rail 103 and reciprocates the nozzle head 106 one time in the main-scanning direction which is along the rail 103, the displacement amount detection section 111 detects the vibration intensity of a vibration which occurs when the nozzle head 106 slips in the sub-scanning direction (Y-axis direction) which is the orthogonal direction to the main-scanning direction. Then, the displacement amount detection section 111 outputs the displacement amount signal regarding the vibration intensity to the control section 119. The control section 119 stores waveform data of the displacement amount signal in a memory 118. When a value of the displacement amount signal is positive, the value thereof indicates that the displacement is to the right in a travelling direction of the nozzle head 106, for example. When a value of the displacement amount signal is negative, the value thereof indicates that the displacement is to the left in the travelling direction of the nozzle head 106, for example.

The displacement amount detection section 111 may be equipped with the carriage 105 as shown in FIG. 5B.

Furthermore, the displacement amount detection section 111 may use the average value of a plurality of displacement detected by reciprocating the carriage 105 along the rail 103 multiple times as a displacement amount.

The vibration intensity detected by the displacement amount detection section 111 also indicates a distortion peculiar to the rail 103, the distortion which is resulted from bumpiness or the like of the rail 103. That is, the more the rail 103 is distorted, the larger the vibration detected by the displacement amount detection section 111 is. Hence, the vibration intensity and the displacement amount signal are correlative with the distortion of the rail 103. Consequently, the vibration intensity which is correlative with the distortion of the rail 103 and the displacement amount signal which corresponds to the vibration intensity can be correlated with the rail 103 in the length direction thereof.

The control section 119 generates a driving signal for moving the nozzle head 106 in the offset direction which offsets a displacement amount of the nozzle head 106 relative to the substrate 121 in accordance with a displacement amount signal which is regarding vibration intensity detected by the displacement amount detection section 111, and which is stored in the memory 118. For example, the control section 119 generates a driving signal which has the same magnitude level as the magnitude of the displacement amount signal and whose value (positive or negative) is opposite thereto. In this case, the driving signal is generated by converting the phase of the displacement amount signal into the opposite. Waveform data regarding the generated driving signal is also stored in the memory 118.

The control section 119 outputs the generated driving signal to the position adjustment section 110 so as to operate the position adjustment section 110 such that the amount of the displacement of the nozzle head 106, the displacement which occurs when the carriage 105 vibrates, is offset.

More specifically, the control section 119 operates the position adjustment section 110 by outputting a driving signal in response to the start of movement of the carriage 105. Then, as shown in FIG. 6, the position adjustment section 110 offsets the amount of displacement of the nozzle head 106, the displacement which occurs following a vibration of the carriage 105, by performing an offset action downwardly in the Y-axis direction at a position where the displacement of the nozzle head 106 occurs upwardly in the Y-axis direction following the vibration of the carriage 105 which occurs upwardly in the Y-axis direction because of a distortion of the rail 103 or the like.

Similarly, the position adjustment section 110 offsets the amount of displacement of the nozzle head 106, the displacement which occurs following a vibration of the carriage 105, by performing the offset action upwardly in the Y-axis direction at a position where the displacement of the nozzle head 106 occurs downwardly in the Y-axis direction following the vibration of the carriage 105 which occurs downwardly in the Y-axis direction because of a distortion of the rail 103 or the like.

The control section 119 continuously operates the position adjustment section 110 based on a driving signal while the carriage 105 moves the nozzle head 106 in the main-scanning direction. As a result, by the offset action of the position adjustment section 110, the amount of the displacement of the nozzle head 106, the displacement which occurs because of the distortion peculiar to the rail 103, can be offset. Accordingly, the nozzle head 106 can be moved linearly relative to the substrate 121, as shown in FIG. 7.

The offset processing is not limited to being performed by operating the position adjustment section 110, the offset processing to offset the amount of displacement of the nozzle head 106, the displacement which occurs following a vibration of the carriage 105, based on a driving signal which the control section 119 generates in accordance with a displacement amount signal which corresponds to vibration intensity detected by the displacement amount detection section 111.

For example, the offset processing to offset the amount of displacement of the nozzle head 106, the displacement which occurs following a vibration of the carriage 105, can be performed by making the moving device 102 function as a position adjustment section.

In this case, the control section 119 generates a driving signal in accordance with a displacement amount signal which is regarding vibration intensity detected by the displacement amount detection section 111, and which is stored in the memory 118, the driving signal which has the same magnitude level as the magnitude of a displacement amount signal and whose value (positive or negative) is the same as the value of the displacement amount signal. That is, the driving signal is a signal whose phase is the same as the phase of the displacement amount signal.

The control section 119 outputs the driving signal to the moving device 102, and operates the moving device 102 such that the amount of the displacement of the nozzle head 106, the displacement which occurs following the vibration of the carriage 105, is offset. The control section 119 operates the moving device 102 such that the worktable 101 is moved in the same direction (sub-scanning direction) with the same magnitude (distance) as the direction and the magnitude (distance) of the displacement amount of the nozzle head 106. By moving the worktable 101 in the sub-scanning direction in accordance with the displacement amount of the nozzle head 106, the substrate 121 disposed on the worktable 101 conforms to the displacement of the nozzle head 106. Therefore, the amount of the displacement of the nozzle head 106, the displacement which occurs following the vibration of the carriage 105, can be offset.

The function of the control section 119 to generate a driving signal in accordance with a displacement amount signal and to output the generated driving signal to the position adjustment section 110 may be performed by a logic circuit or by execution of a program.

### (2) Operation of Application Device According to First Embodiment and Application Method Thereby

In the following, operation of the application device 100, an application method by using the application device 100, and the like are described.

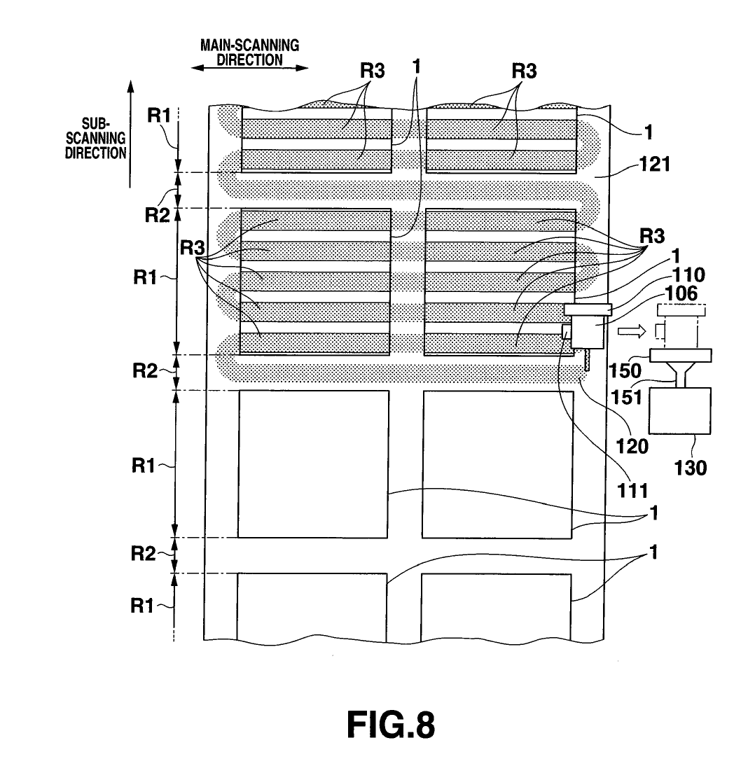

FIG. 8 is an explanatory diagram showing a pattern of application of a liquid, the application performed by moving a nozzle head of the application device according to the first embodiment of the present invention.

First, the control section 119 operates the carriage 105 in a state where the liquid 120 is not discharged from the nozzle hole 168 of the nozzle head 106, and reciprocates the carriage 105 with the nozzle head 106 one time in the main-scanning direction along the rail 103.

While the nozzle head 106 reciprocates one time along the rail 103, the displacement amount detection section 111 detects the amount of displacement of the nozzle head 106 in the sub-scanning direction, the displacement which occurs while the nozzle head 106 moves in the main-scanning direction.

The displacement amount detection section 111 detects the amount of the displacement of the nozzle head 106 in the sub-scanning direction, the displacement caused by a distortion peculiar to the rail 103, and outputs vibration intensity and a displacement amount signal regarding the detected amount of the displacement of the nozzle head 106 to the control section 119.

The control section 119 stores waveform data regarding the vibration intensity and the displacement amount signal, which are supplied from the displacement amount detection section 111, in the memory 118.

The control section 119 generates a driving signal in accordance with the vibration intensity and the displacement amount signal, and stores waveform data regarding the driving signal.

In the above, the carriage 105 is reciprocated one time in the main-scanning direction along the rail 103, but not limited thereto. The carriage 105 may be reciprocated multiple times in the main-scanning direction along the rail 103, and the displacement amount detection section 111 may use the average value of a plurality of displacement detected by reciprocating the carriage 105 multiple times as a displacement amount.

Next, the liquid tank 108 is filled with the liquid 120. In a case where the liquid tank 108 is replaceable, the liquid tank 108 filled with the liquid 120 is set to the supply pipe 107, and the supply device 116 is set to the liquid tank 108.

At this point, the supply pipe 107 is empty, namely, the supply pipe 107 is not filled with the liquid 120.

After that, the control section 119 operates the carriage 105 so as to move the nozzle head 106 to the standby position. At the standby position, the airtight cap 150 closely contacts with the lower end of the nozzle head 106.

Then, while operating the vacuum pump 140 so as to reduce the pressures in the supply pipe 107 and the nozzle head 106, the control section 119 operates the supply device 116. Consequently, the liquid 120 in the liquid tank 108 flows into the supply pipe 107, and then is supplied into the nozzle head 106.

In addition, the control section 119 determines the set flow rate of the massflow controller 109, and adjusts the amount of the liquid 120 which is discharged from the nozzle head 106.

Next, the substrate 121 is disposed on the worktable 101.

As shown in FIG. 8, a plurality of panel regions R1 and a plurality of margin regions R2 are arranged alternately on the substrate 121. The plurality of panel regions R1 is cut out from the substrate 121 at the end so as to be a plurality of EL panels 1, respectively, and a plurality of application target regions R3 to which the liquid 120 is applied is provided in each of the panel regions R1. Each of the margin regions R2 is located between the panel regions R1, and is a non-application target region to which the liquid 120 is not necessary to be applied.

Next, the control section 119 operates the carriage 105. At the time, the control section 119 keeps operating the supply device 116 which supplies the liquid 120 stored in the liquid tank 108 into the supply pipe 107.

The control section 119 operates the carriage 105 to move the nozzle head 106 with the carriage 105 in the main-scanning direction.

Since the supply device 116 keeps operating at the time, the liquid 120 stored in the liquid tank 108 is supplied to the nozzle head 106, and a flow rate of the liquid 120 flowing in the supply pipe 107 is controlled by the massflow controller 109 to be kept at the set flow rate which is fixed.

Accordingly, while the carriage 105 moves, the liquid 120 is continuously discharged from the nozzle hole 168 of the nozzle head 106. As a result, the liquid 120 discharged from the nozzle hole 168 of the nozzle head 106 is applied linearly to one of the application target regions R3 on the substrate 121, so that a linear organic layer pattern which is along the main-scanning direction is formed in the application target region R3.

When the carriage 105 moving from one end to the other end of the moving area thereof reaches the other end, the control section 119 stops the carriage 105.

Next, the control section 119 controls the moving device 102 to move the worktable 101 and the substrate 121 through a prescribed distance in the sub-scanning direction.

At the time as well, the liquid 120 is continuously discharged from the nozzle hole 168 of the nozzle head 106. As a result, a linear organic layer pattern which is along the sub-scanning direction is formed on the substrate 121. The moving device 102 stops thereafter.

Next, the control section 119 operates the carriage 105 to move the nozzle head 106 with the carriage 105 the other way around in the main-scanning direction.

At the time as well, the liquid 120 is continuously discharged from the nozzle hole 168 of the nozzle head 106. As a result, the liquid 120 discharged from the nozzle hole 168 of the nozzle head 106 is applied linearly to another of the application target regions R3 on the substrate 121, so that a linear organic layer pattern which is along the main-scanning direction is formed in the application target region R3.

When the carriage 105 moving from the other end to the one end of the moving area thereof reaches the one end, the control section 119 stops the carriage 105.

Next, the control section 119 controls the moving device 102 to move the worktable 101 and the substrate 121 through a prescribed distance in the sub-scanning direction.

At the time as well, the liquid 120 is continuously discharged from the nozzle hole 168 of the nozzle head 106. As a result, a linear organic layer pattern which is along the sub-scanning direction is formed on the substrate 121. The moving device 102 stops thereafter.

After that, the control section 119 repeats controlling the carriage 105 and the moving device 2, and controlling the supply device 116 and the massflow controller 109.

Consequently, the carriage 105 repeatedly moves from end to end of the moving area thereof while the liquid 120 is continuously discharged from the nozzle hole 168 of the nozzle head 106. Also, the moving device 2 moves the worktable 101 and the substrate 121 through a prescribed distance in the sub-scanning direction when the carriage 105 reaches an end (the one end or the other end) of the moving area thereof.

As a result, as shown in FIG. 8, an organic layer pattern which looks as if a kudzu vine is folded is formed on the substrate 121 by the liquid 120 discharged from the nozzle head 106.

The control section 119 repeats controlling the carriage 105, the moving device 102, the supply device 116, the massflow controller 109, and the like to apply the liquid 120 onto the substrate 121, during which the control section 119 outputs a driving signal generated beforehand to the position adjustment section 110.

That is, when the control section 119 operates the carriage 105 to move the nozzle head 106 with the carriage 105 in the main-scanning direction so as to apply the liquid 120 to the substrate 121, the control section operates the position adjustment section 110 based on a driving signal.

Then, the position adjustment section 110 which is operated based on the driving signal adjusts a position of the nozzle head 106 by moving in the sub-scanning direction, and offsets the amount of displacement of the nozzle head 106 in the sub-scanning direction, the displacement which occurs following a vibration of the carriage 105 resulted from a distortion peculiar to the rail 103.

The position adjustment section 110 offsets the amount of the displacement of the nozzle head 106 in the sub-scanning direction, the displacement which occurs following the vibration of the carriage 105, namely, offsets the amount of the displacement of the nozzle head 106 relative to the substrate 121.

Consequently, while the carriage 105 moves the nozzle head 106 in the main-scanning direction, the amount of a displacement of the nozzle head 106 in the sub-scanning direction is offset by the position adjustment section 110 being operated, and hence, the nozzle head 106 can linearly move in the main-scanning direction relative to the substrate 121.

Since the nozzle head 106 whose amount of displacement in the sub-scanning direction is offset linearly moves in the main-scanning direction relative to the substrate 121, the liquid 120 discharged from the nozzle head 106 is linearly applied onto the substrate 121. As a result, a linear organic layer pattern which is along the main direction is formed in each of the application target regions R3 on the substrate 121.

The control section 119 recognizes a current position of the nozzle head 106 moving and applying the liquid 120. The control section 119 is structured to be able to identify a current position of the nozzle head 106 relative to the substrate 121 by performing prescribed arithmetic processing based on the size of the substrate 121 and the respective moving areas and moving speeds of the carriage 105 and the moving device 102, and/or structured to be able to estimate, from the current position, a position where the nozzle head is in a prescribed time by performing arithmetic processing similar to the prescribed arithmetic processing.

The control section 119 moves the nozzle head 106 to the standby position where the airtight cap 150 is at a timing when the nozzle head 106 is at a position corresponding to one of the margin regions R2 of the substrate 121, in order to remove air bubbles in the nozzle head 106 or to fill the liquid tank 108 with the liquid 121, before the discharge of the liquid 120 from the nozzle head 106 becomes impossible. Thereby, the liquid 120 does not run out in the panel regions R1 of the substrate 121.

As described above, according to the application device 100 in the first embodiment, when the carriage 105 is moved along the rail 103, and the nozzle head 106 is moved in the main-scanning direction so as to apply the liquid 120 to the substrate 121, the amount of displacement of the nozzle head 106 in the sub-scanning direction can be offset by the position adjustment section 110 being operated, the displacement which occurs following a vibration of the carriage 105 caused by a distortion peculiar to the rail 103.

In addition, according to the application device 100, the nozzle head 106 can be linearly moved in the main-scanning direction relative to the substrate 121 by offsetting a displacement amount of the nozzle head 106 in the sub-scanning direction by the position adjustment section 110 being operated.

Moreover, according to the application device 100, the liquid 120 discharged from the nozzle head 106 can be appropriately applied to the substrate 121 by linearly moving the nozzle head 106 in the main-scanning direction relative to the substrate 121.

More specifically, the liquid 120 can be appropriately applied to the substrate 121 (substrate 10) by linearly moving the nozzle head 106 in the main-scanning direction along each of a plurality of banks 13 (described below) which are partition walls extending in the main-scanning direction, without climbing over the banks 13 in the sub-scanning direction and/or being applied to the outside of the application target regions R3. Each of the application target regions R3 is located between the banks 13 which are next to each other.

### Second Embodiment

### (3) Structure of Application Device According to Second Embodiment

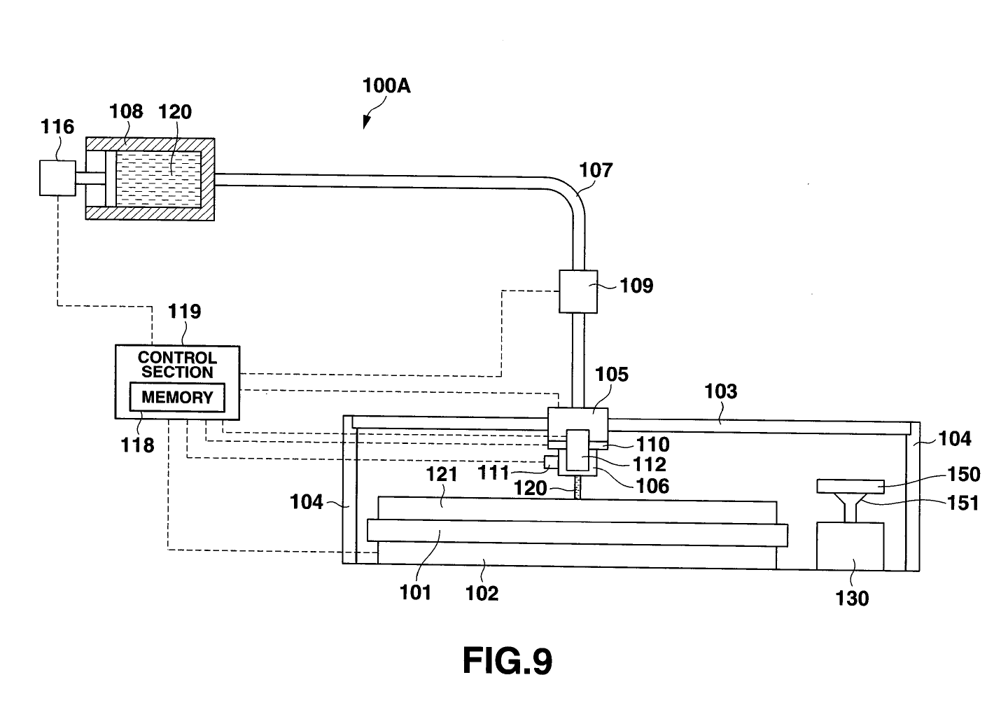

FIG. 9 is a schematic view showing the application device according to a second embodiment of the present invention.

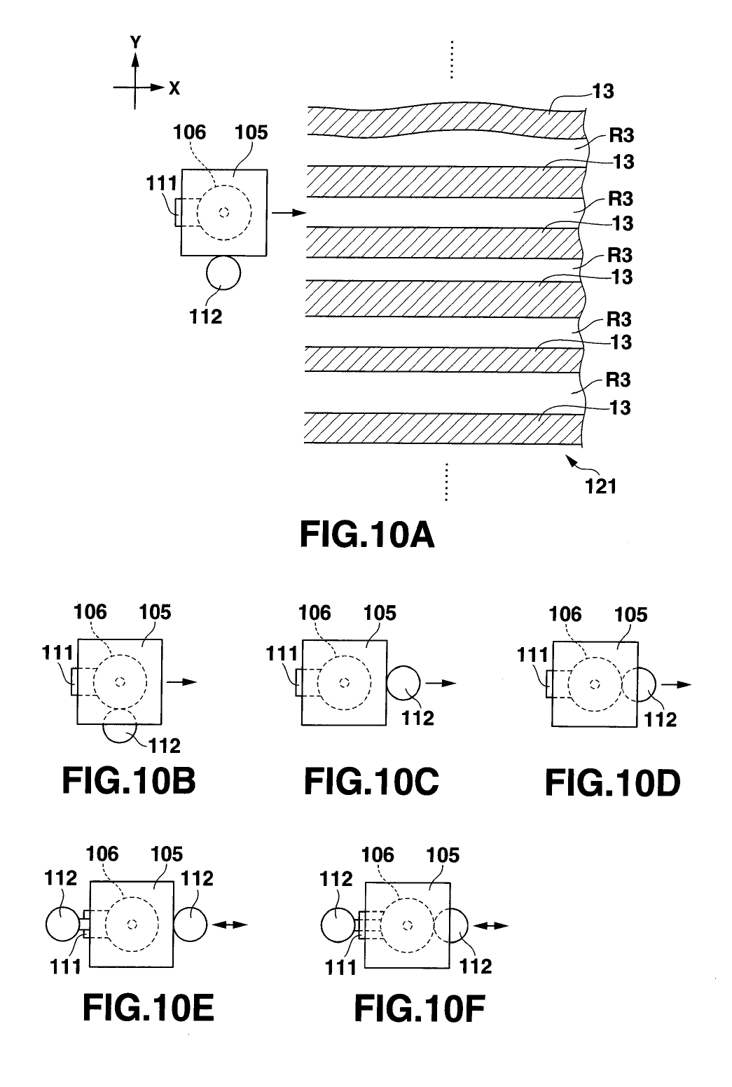

FIG. 10A is a diagram illustrating detection of a distortion of a bank by an image pickup section of the application device according to the second embodiment of the present invention, and FIGS. 10B to 10F show different setting positions of the image pickup section, respectively.

FIGS. 10A to 10F show the principal part of the application device viewed from above the carriage 105.

The application device 100A according to the second embodiment is different from the application device 100 according to the first embodiment in that the application device 100A includes an image pickup section 112 which can pick up an image of the top surface of the substrate 121 disposed on the worktable 101. The image pickup section 112 is equipped with the carriage 105, for example.

The image pickup section 112 includes, for example, a pickup element such as a CCD, and picks up an image of the top surface of the substrate 121 while moving in the main-scanning direction with the nozzle head 106 which moves when the carriage 105 moves. The image pickup section 112 picks up an image of an area of the substrate 121, the area including at least one application target region R3 to which the liquid 120 is applied in the main-scanning direction. (See FIG. 10A.)

The image pickup section 112 picks up an image of a position at the application target region R3 on the substrate 121, the position to which the liquid 120 is to be applied.

The image pickup section 112 picks up an image of banks 13 (described below) which are partition walls extending in the main-scanning direction and which sandwich the application target region R3 to which the liquid 120 is applied on the substrate 121.

The image pickup section 112 picks up an image of an application target region R3 and/or partition walls (banks 13) which are features of the substrate 121, for example, centering on a mark or the like provided with the substrate 121. Image pickup data of the substrate 121 whose image is picked up by the image pickup section 112 is output to the control section 119.

The image pickup section 112 is controlled by the control section 119.

The position adjustment section 110 is operated based on a driving signal so as to move the nozzle head 106 in accordance with a displacement amount of the nozzle head 106 in the sub-scanning direction, the displacement amount which is detected by the displacement amount detection section 111, in the offset direction which offsets the displacement amount of the nozzle head 106 relative to the substrate 121. In addition, the position adjustment section 110 is operated to adjust a position of the nozzle head 106 based on the features of the substrate 121 by moving the nozzle head 106 in the sub-scanning direction, the features whose image is picked up by the image pickup section 112. The position of the nozzle head 106 is adjusted such that the nozzle head 106 is disposed at a position which corresponds to an application target region R3 of the substrate 121. More specifically, the position of the nozzle head 106 is adjusted such that the nozzle hole 168 of the nozzle head 106 is disposed at the near-center of the application target region R3 in a width direction thereof which is the orthogonal direction to the main-scanning direction.

The control section 119 allows the image pickup section 112 to pick up an image of the area of the substrate 121, the area including an application target region R3, while moving the carriage 105 along the rail 103 so as to move the image pickup section 112 in the main-scanning direction. The image pickup data of the substrate 121 whose image is picked up by the image pickup section 112 is correlated with a position of the carriage 105 which moves along the rail 103.

The control section 119 performs prescribed image recognition processing on the image pickup data of the substrate 121 whose image is picked up by the image pickup section 112, extracts banks 13 which are the features of the substrate 121, extracts reference lines which are lined with the side walls of the banks 13, respectively, and obtains a center line of the application target region R3 which is sandwiched by the banks 13.

As shown in FIG. 10A, when a bank 13 formed on the substrate 121 (substrate 10) is formed as designed, the extracted reference line regarding the bank 13 is linearly extended in the main-scanning direction at a prescribed position.

On the other hand, when a bank 13 is not formed as designed, and the width of the bank 13, the width being along the sub-scanning direction, is uniformly wide or uniformly narrow, the extracted reference line regarding the bank 13 is linearly extended in the main-scanning direction at a position which is slipped in the sub-scanning direction.

Also, when a bank 13 is not formed as designed and is distorted, the extracted reference line regarding the bank 13 is irregularly extended. For example, the reference line is distorted and bent in the sub-scanning direction.

The control section 119 generates position adjustment amount data based on the extracted reference lines of the banks 13 for the position adjustment section 110 to move the nozzle head 106 in the sub-scanning direction such that the position of the nozzle head 106 is adjusted to be a position corresponding to the application target region R3 between the banks 13 on the substrate 121. The position adjustment data corresponds to slips and/or distortions of the extracted reference lines in the sub-scanning direction which is the orthogonal direction to the main-scanning direction, and is correlated with a position of the carriage 105 which moves along the rail 103.

That is, the position adjustment amount data defines a moving amount of the nozzle head 106 in the sub-scanning direction, the movement amount for adjusting a position of the nozzle head 106 to be at a position corresponding to the application target region R3 in accordance with a position of the nozzle head 106 which moves in the main-scanning direction along the rail 103. The generated position adjustment amount data is stored in the memory 118.

The control section 119 moves the nozzle head 106 in the sub-scanning direction by operating the position adjustment section 110 according to the position adjustment amount data generated based on the image pickup data of the substrate 121 whose image is picked up by the image pickup section 112. Consequently, the nozzle head 106 is disposed at a position corresponding to the application target region R3, the position which keeps a prescribed amount (distance) from the banks 13 in a horizontal direction. More specifically, the nozzle hole 168 of the nozzle head 106 is disposed at a position corresponding to the near-middle between the banks 13.

The liquid 120 discharged from the nozzle head 106, which moves in the main-scanning direction, can be uniformly applied to the application target region R3 in the width direction thereof by operating the position adjustment section 110 by the control section 119 based on the position adjustment amount data so as to dispose the nozzle hole 168 of the nozzle head 106 at a position corresponding to the near-middle between the banks 13, and accordingly to dispose the nozzle head 106 at a position corresponding to the application target region R3 between the banks 13.

The processing to dispose the nozzle head 106 at a position corresponding to an application target region R3 between banks 13 based on the position adjustment amount data is not limited to be performed by operating the position adjustment section 110 by the control section 119.

For example, the processing to dispose the nozzle head 106 at a position corresponding to an application target region R3 between banks 13 may be performed by making the moving device 102 function as a position adjustment section. More specifically, the moving device 102 moves the worktable 101 in the sub-scanning direction based on the position adjustment amount data, and accordingly, the substrate 121 disposed on the worktable 101 is moved relative to the nozzle head 106. As a result, the processing mentioned above is performed.

Practically, the control section 119 operates the position adjustment section 110 to move the nozzle head 106 in the sub-scanning direction based on a moving amount which is calculated from a moving amount of the nozzle head 106 according to a driving signal and a moving amount of the nozzle head 106 according to the position adjustment amount data.

That is, the control section 119 moves the nozzle head 106 in the sub-scanning direction such that the amount of displacement of the nozzle head 106 in the sub-scanning direction is offset, the displacement which occurs while the carriage 105 moves in the main-scanning direction, and the nozzle head 106 is disposed at a position corresponding to an application target region R3 between banks 13 in accordance with the respective shapes of the banks 13 formed on the substrate 121.

The application device 100A and the application device 100 have a similar structure and operate in a similar way, except for what is described above.

In the embodiment described above, the image pickup section 112 is equipped with the carriage 105, but not limited thereto. As shown in FIG. 10B, the image pickup section 112 may be equipped with the nozzle head 106.

Also, as shown in FIGS. 10C and 10D, the image pickup section 112 may be provided on the extension of the nozzle head 106 in the main-scanning direction. In this case, the center line of the application target region R3 on which the application is performed can be obtained at the same time as the application is performed. Accordingly, an effect of reducing the capacity of the memory 118 of the control section 119 can be obtained. In this case as well, the image pickup section 112 may be equipped with the carriage 105 as shown in FIG. 10C or may be equipped with the nozzle head 106 as shown in FIG. 10D.

Furthermore, as shown in FIGS. 10E and 10F, two image pickup sections 112 may be provided on the extension of the nozzle head 106 in the main-scanning direction and at the front and the back of the moving direction of the nozzle head 106. In this case, the center line of the application target region R3 can be obtained in two-way application in the main-scanning direction, too. In this case too, the image pickup section 112 may be equipped with the carriage 105 as shown in FIG. 10E or may be equipped with the nozzle head 106 as shown in FIG. 10F.

### (4) Operation of Application Device According to Second Embodiment

Next, operation of the application device 100A according to the second embodiment is described.

Here, the description is given to the operation of the position adjustment section 110 to dispose the nozzle head 106 in accordance with the respective shapes of the banks 13 formed on the substrate 121 at a position which corresponds to an application target region R3 between banks 13. While the position adjustment section 110 is operated to adjust a position of the nozzle head 106 in accordance with the respective shapes of the banks 13, the position adjustment section 110 is also operated to offset the amount of displacement of the nozzle head 106 in the sub-scanning direction, the displacement which occurs while the carriage 105 moves in the main-scanning direction. The operation of the position adjustment section 110 to offset the amount of displacement of the nozzle head 106 is similar to the operation thereof in the first embodiment, and hence the description thereof is omitted. The descriptions of the other operations of the application device 100A which are similar to the operations of the application device 100 according to the first embodiment are also omitted or simplified.

First, the substrate 121 is disposed on the worktable 101. At the time, the substrate 121 is set to the worktable 101 such that banks 13 formed on the substrate 121 extend in the main-scanning direction (X-axis direction).

Next, the control section 119 operates the carriage 105 in a state where the liquid 120 is not discharged from the nozzle hole 168 of the nozzle head 106, and reciprocates the carriage 105 with the nozzle head 106 and the image pickup section 112 one time in the main-scanning direction along the rail 103.

While the image pickup section 112 reciprocates one time along the rail 103, the image pickup section 112 picks up an image of an area of the substrate 121, the area including an application target region R3 and at least one bank 13 contiguous to the application target region R3 to which the liquid 120 discharged from the nozzle head 106 is to be applied at the next step.

The control section 119 extracts a reference line regarding the bank 13 based on the image pickup data of the image picked up by the image pickup section 112.

The control section 119 generates the position adjustment amount data based on the extracted reference line, the position adjustment amount data which is used for moving the nozzle head 106 in the sub-scanning direction. The position adjustment amount data is stored in the memory 118.

While the image pickup section 112 and the nozzle head 106 reciprocate one time along the rail 103, the displacement amount detection section 111 detects a displacement amount of the nozzle head 106, and outputs vibration intensity and a displacement amount signal regarding the displacement amount to the control section 119.

The control section 119 stores waveform data corresponding to the vibration intensity and the displacement amount signal which are supplied from the displacement amount detection section 111 in the memory 118.

The liquid tank 108 is filled with the liquid 120, and the liquid 120 in the liquid tank 108 is supplied into the supply pipe 107, and then to the nozzle head 106.

Next, the control section 119 operates the carriage 105 to move the nozzle head 106 with the carriage 105 in the main-scanning direction. At the time, the supply device 116 keeps operating, so that the liquid 120 in the liquid tank 108 is supplied to the nozzle head 106, and the massflow controller 109 controls a flow rate of the liquid 120 flowing in the supply pipe 107 to be kept at the set flow rate which is fixed. As a result, the liquid 120 is continuously discharged from the nozzle hole 168 of the nozzle head 106 while the carriage 105 moves.

The discharged liquid 120 is applied onto the substrate 121 linearly, and hence a linear organic layer which is pattern along the main-scanning direction is formed on the substrate 121.

The control section 119 operates the position adjustment section 110 based on the position adjustment amount data which is generated beforehand to move the nozzle head 106 in the sub-scanning direction, and to dispose the nozzle hole 168 of the nozzle head 106 at a position corresponding to the near-middle between the banks 13, while operating the carriage 105 and the like to move the nozzle head 106 in the main direction and apply the liquid 120 onto the substrate 121 thereby.

That is, since the nozzle head 106 which moves in the main-scanning direction when the carriage 105 moves is disposed at a position corresponding to the near-middle between the banks 13, the nozzle head 106 moves along the near-middle between the banks 13. Consequently, the liquid 120 discharged from the nozzle head 106 is appropriately applied to the application target region R3 between the banks 13, and applied uniformly in the width direction of the application target region R3.

When the nozzle head 106 applies the liquid 120 to the application target region R3 between the banks 13, and the carriage 105 moves in the main-scanning direction, the image pickup section 112 picks up an image of an area of the substrate 121, the area including the next application target region R3 and at least one bank 13 contiguous to the next application target region R3. The next application target region R3 is located next to the application target region R3 to which the liquid 120 is currently applied, and the liquid 120 is applied to the next application target region R3 next.

The control section 119 extracts a reference line regarding the bank 13 contiguous to the next application target region R3, and generates the position adjustment amount data based on the extracted reference line.

That is, when the control section 119 moves the carriage 105 so as to apply the liquid 120 discharged from the nozzle head 106 to a plurality of application target regions R3, the control section 119 allows the image pickup section 112 to pick up an image of an area of the substrate 121, the area including an application target region R3 to which the nozzle head 106 is going and at least one bank 13 which is contiguous to the application target region R3, so as to extract a reference line regarding the bank 13, and the like. Before the nozzle head 106 reaches the application target region R3 whose image is picked up, and liquid 121 is applied to the application target region R3, the control section 119 generates the position adjustment amount data which is used for disposing the nozzle head 106 at a position corresponding to the application target region R3.

The area of the substrate 121, the area whose image is picked up by the image pickup section 112, is not limited to including an application target region R3 which is the next line to an application target region R3 to which the liquid 120 is currently applied by the nozzle head 106, and a bank 13 which is contiguous to the application target region R3 at the next line. The image pickup section 112 may pick up an image of an area of the substrate 121, the area including an application target region R3 which is located at a few lines ahead of the application target region R3 to which the liquid 120 is currently applied, and a bank 13 which is contiguous to the application target region R3.

As described above, according to the application device 100A in the second embodiment, when the nozzle head 106 is moved in the main-scanning direction to apply the liquid 120 to the substrate 121, the position adjustment section 110 is operated to adjust a position of the nozzle head 106 in the sub-scanning direction in accordance with a position and/or a shape of one or both of banks 13 which are next to each other and whose image is picked up by the image pickup section 112. As a result, the application device 100A can move the nozzle head 106 to a position corresponding to the application target region R3, and adjust a position of the nozzle hole 168 of the nozzle head 106 to be a position corresponding to the near-middle between the banks 13.

According to the application device 100A, the position adjustment section 110 is operated to adjust a position of the nozzle head 106 to be a position corresponding to the application target region R3 between the banks 13, so that the nozzle hole 168 of the nozzle head 106 which moves along the rail 103 moves along the near-middle between the banks 13. As a result, the liquid 120 discharged from the nozzle head 106 can be appropriately applied to the application target region R3 between the banks 13.

More specifically, the nozzle head 106 is moved relative to the substrate 121 (substrate 10) along the banks 13 which extend in the main-scanning direction. As a result, the liquid 120 can be appropriately applied to the application target region R3 between the banks 13, and uniformly applied in the width direction of the application target region R3, without being applied to the outside of the application target region R3.

As described above, in the application device 100A, the image pickup section 112 picks up an image of an area of the substrate 121 when the carriage 105 moves in the main-scanning direction and the nozzle head 106 applies the liquid 120 to a plurality of application target regions R3, each of which is located between banks 13 which are next to each other, and the area described above includes an application target region R3 to which the nozzle head 106 is going and at least one bank 13 which is contiguous to the application target region R3, but is not limited thereto.

As shown in FIGS. 10C and 10D, the image pickup section 112 may be provided on the extension of the nozzle head 106 in the main-scanning direction, and the area of the substrate 121 whose image is picked up by the image pickup section 112 may be including an application target region R3 to which the liquid 120 is currently applied and at least one bank 13 which is contiguous to the application target region R3.

When, as shown in FIG. 10C, the image pickup section 112 is equipped with the carriage 105, and the nozzle head 106 is provided so as to be movable in the sub-scanning direction by the position adjustment section 110, first, the image-pickup section 112 is adjusted such that the center of a range of which the image-pickup section 112 picks up an image (image-pickup range of the image-pickup section 112 hereinafter) is a position to which the liquid 120 discharged from the nozzle head 106 is applied on the substrate 121.

The control section 119 extracts one or both of banks 13 which are the features of the substrate 121, and next to each other, and then extracts a center line between the banks 13 which sandwich an application target region R1, for example, by performing prescribed image recognition processing on the image pickup data of the substrate 121 whose image is picked up by the image pickup section 112.

Then, when the control section 119 moves the carriage 105 to apply the liquid 120 discharged from the nozzle head 106 to the application target region R3 along the banks 13 which extend in the main-scanning direction, the control section 119 allows the image pickup section 112 to pick up an image of the banks 13 which are located at the both sides of the application target region R3, respectively, and extracts a center line between the banks 13.

When the center line extracted by the control section 119 from the image pickup data is, for example, distorted to the right, the application target region R3 between the banks 13 is distorted to the right relative to the image pickup section 112 (carriage 105). Hence, the control section 119 operates the position adjustment section 110 so as to move the nozzle head 106 to the right in the travelling direction thereof for a moving amount corresponding to the amount of the distortion of the center line. Similarly, when the line extracted by the control section 119 from the image pickup data is, for example, distorted to the left, the application target region R3 between the banks 13 is distorted to the left relative to the image pickup section 112 (carriage 105). Hence, the control section 119 operates the position adjustment section 110 so as to move the nozzle head 106 to the left in the travelling direction thereof for a moving amount corresponding to the amount of the distortion of the center line.

That is, by picking up an image of an application target region R3 to which the liquid 120 discharged from the nozzle head 106 is currently applied and banks 13 which sandwich the application target region R3, the control section 119 instantly judges a distortion of the application target region R3 and/or the banks 13 in the sub-scanning direction, and operates the position adjustment section 110. Then, the position adjustment section 110 moves the nozzle head 106 in the sub-scanning direction, and adjusts a position of the nozzle head 106 to be a position corresponding to the application target region R3.

By these operations of the image pickup section 112 and the position adjustment section 110 as well, the position of the nozzle head 106 is adjusted to be the position corresponding to the application target region R3 between the banks 13, and the nozzle hole 168 of the nozzle head 106 can be moved along the near-middle between the banks 13. Accordingly, the liquid 120 discharged from the nozzle head 106 can be appropriately applied to the application target region R3 between the banks 13, and uniformly applied in the width direction of the application target region R3.

When, as shown in FIG. 10D, the image pickup section 112 is equipped with the nozzle head 106 so as to be movable in the sub-scanning direction by the position adjustment section 110, and the nozzle head 106 and the image pickup section 112 are moved together in the sub-scanning direction by operating the position adjustment section 110, the image pickup section 112 and the nozzle head 106 are set to the application device 110A such that the center of the image-pickup range of the image pickup section 112 corresponds to the position of the nozzle head 106, for example.

In this case, the control section 119 extracts one or both of banks 13 which are the features of the substrate 121, and next to each other, and then extracts a center line between the banks 13 which sandwich an application target region R1, for example, by performing prescribed image recognition processing on the image pickup data of the substrate 121 whose image is picked up by the image pickup section 112.

Then, the control section 119 operates the position adjustment section 110 such that the center line extracted by the control section 119 from the image pickup data always be the center of the image-pickup range of the image pickup section 112. As a result, the nozzle head 106 can be always disposed at a position corresponding to the near-middle of the application target region R3 between the banks 13.

That is, the control section 119 operates the position adjustment section 119 such that the center of the image-pickup range of the image pickup section 112 becomes the near-middle of the application target region R3 between the banks 13 while allowing the image pickup section 112 to pick up an image of the application target region R3 to which the liquid 120 discharged from the nozzle head 106 is currently applied and the banks 13 which sandwich the application target region R3. As a result, the nozzle head 106 whose position corresponds to the center of the image-pickup range of the image pickup section 112 is adjusted to be disposed at a position corresponding to the application target region R3.

By these operations of the image pickup section 112 and the position adjustment section 110 as well, the position of the nozzle head 106 can be adjusted to be the position corresponding to the application target region R3 between the banks 13, and the nozzle hole 168 of the nozzle head 106 can be moved along the near-middle between the banks 13. Accordingly, the liquid 120 discharged from the nozzle head 106 can be appropriately applied to the application target region R3 between the banks 13.

In addition, as shown in FIGS. 10E and 10F, when two image pickup sections 112 are severally provided on the extension of the nozzle head 106 in the main-scanning direction, and at the front and the back of the moving direction of the nozzle head 106, the similar operations described above referring FIGS. 10C and 10D can be appropriately performed in two-way application in the main-scanning direction. Accordingly, the liquid 120 can be more uniformly applied to the application target region R3.

### (5) Structure of Electroluminescence Display Panel

Next, the structure of an electroluminescence (EL) panel 1 which is manufactured by using the application device according to the embodiments of the present invention is described.

A plurality of EL display panels 1 are formed on the large substrate 121, and each of the EL display panels 1 is cut out therefrom, as shown in FIG. 8.

The large substrate 121 is divided into a plurality of small substrates 10, each of which corresponds to each of the EL panels 1.

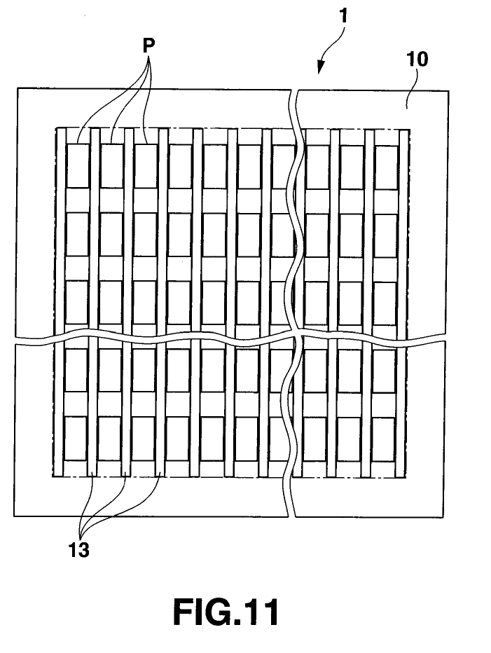

FIG. 11 is a plane view showing an arrangement of a plurality of pixels P of the EL panel 1 which is a light-emitting panel.

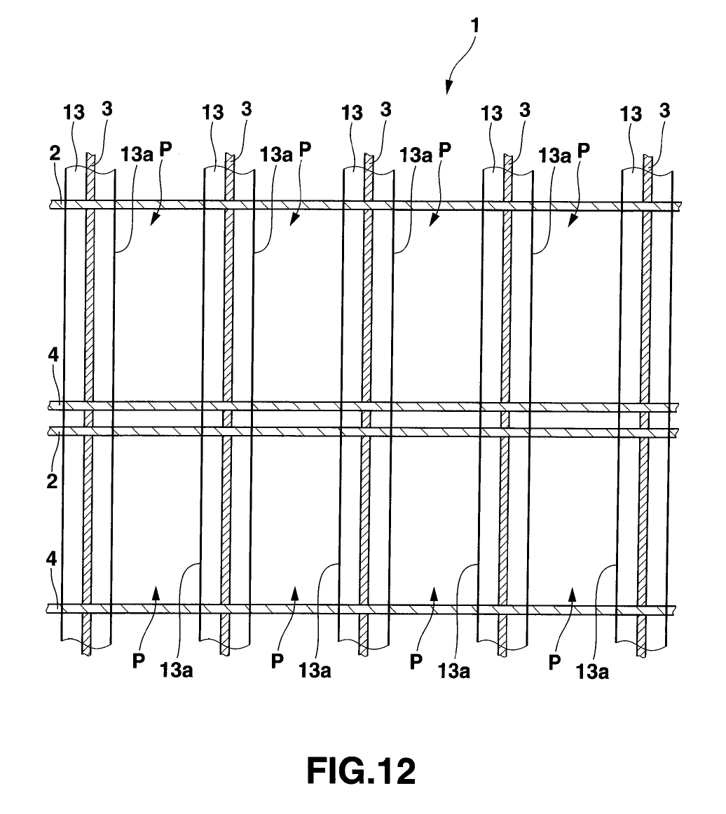

FIG. 12 is a plane view showing the schematic structure of the EL panel 1.

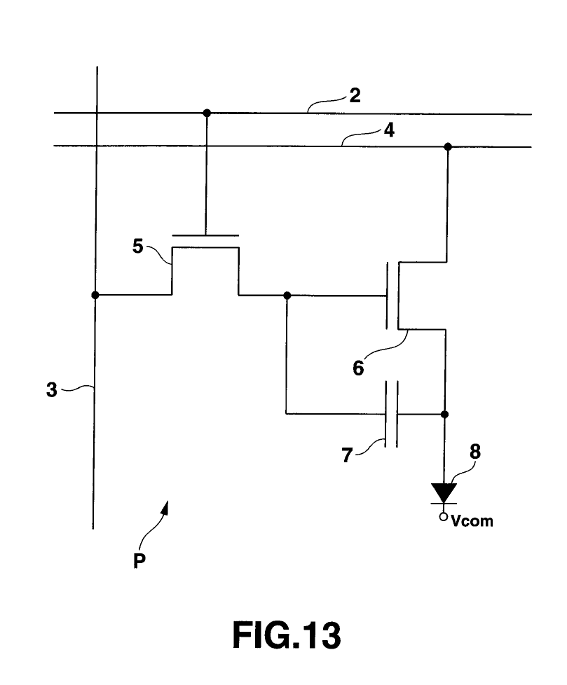

FIG. 13 is a circuit diagram showing a circuit for one pixel of the EL panel 1 which is driven by an active matrix driving method.

As shown in FIGs. 11 and 12, a plurality of pixels P, each of which emits light of red (R), green (G), or blue (B), is disposed in a matrix of a prescribed pattern on the EL panel 1.

On the EL panel 1, a plurality of scanning lines 2 are arranged to be almost parallel to each other in the row direction, and a plurality of signal lines 3 are arranged to be almost parallel to each other in the column direction. The signal lines 3 are almost the orthogonal direction to the scanning lines 2 viewed from above.

Each of a plurality of voltage supply lines 4 is provided between the scanning lines 2 which are next to each other, and provided parallel to the scanning lines 2. An area which is enclosed by a scanning line 2, two signal lines 3 which are contiguous to the scanning line 2, and a voltage supply line 4 corresponds to a pixel P.

Of the plurality of pixels P of the EL panel 1, a plurality of pixels P which emit light of R, a plurality of pixels P which emit light of G, and a plurality of pixels P which emit light of B are arranged along the signal lines 3, respectively, along the arranged direction of the signal lines 3. Also, the pixels P which emit light of R, G, and B are arranged in the arranged direction of the scanning lines 2 in the order of a pixel P which emits light of R, a pixel P which emits light of G, and a pixel P which emits light of B.

A plurality of banks 13 which are partition walls extending in a direction parallel to the signal lines 3 are provided on the EL panel 1. Prescribed carrier transfer layers (hole injection layers 8B and light-emitting layers 8C described below) are provided in each area sandwiched by the banks 13 which are contiguous to each area, and each area becomes a light-emitting area of the pixels P for emitting light of each color. That is, the banks 13 partition the pixels P of the EL panel 1 into groups of pixels P, each of the groups thereof emitting light of red, green, or blue. Each of the carrier transfer layers transfers electron holes or electrons by applying a voltage.

As shown in FIGS. 12 and 13, the scanning lines 2, the signal lines 3 which are the orthogonal direction to the scanning lines 2, and the voltage supply lines 4 which are parallel to the scanning lines 2 are provided on the EL panel 1.

A switching transistor 5 which is a thin film transistor, a driving transistor 6 which is a thin film transistor, a capacitor 7, and an EL element 8 are provided in each pixel P of the EL panel 1.

In each pixel P, the gate of the switching transistor 5 is connected to the scanning line 2, one of the drain and the source of the switching transistor 5 is connected to the signal line 3, and the other of the drain and the source of the switching transistor 5 is connected to one of two electrodes of the capacitor 7 and to the gate of the driving transistor 6.

One of the drain and the source of the driving transistor 6 is connected to the voltage supply line 4, and the other of the drain and the source of the driving transistor 6 is connected to the other of the two electrodes of the capacitor 7 and to the anode of the EL element 8.

The cathode of the EL element 8 of each pixel P maintains a constant voltage Vcom, namely, is grounded, for example.

In the periphery of the EL panel 1, each scanning line 2 is connected to a scanning driver. Each voltage supply line 4 is connected to a constant voltage source or a driver which appropriately outputs a voltage signal.

Each signal line 3 is connected to a data driver. The EL panel 1 is driven by these drivers by using the active matrix driving method. Prescribed electric power is supplied to each voltage supply line 4 by the constant voltage source or the driver mentioned above.

Next, the EL panel 1 and the circuitry of a pixel P thereof are described.

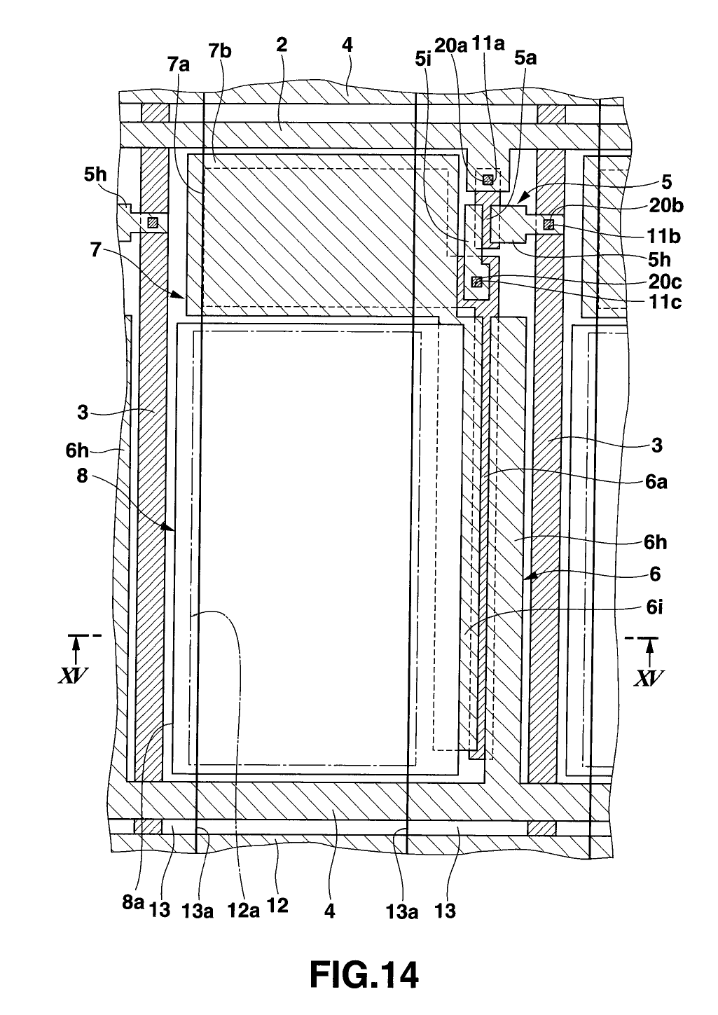

FIG. 14 is a plane view showing one pixel P of the EL panel 1.

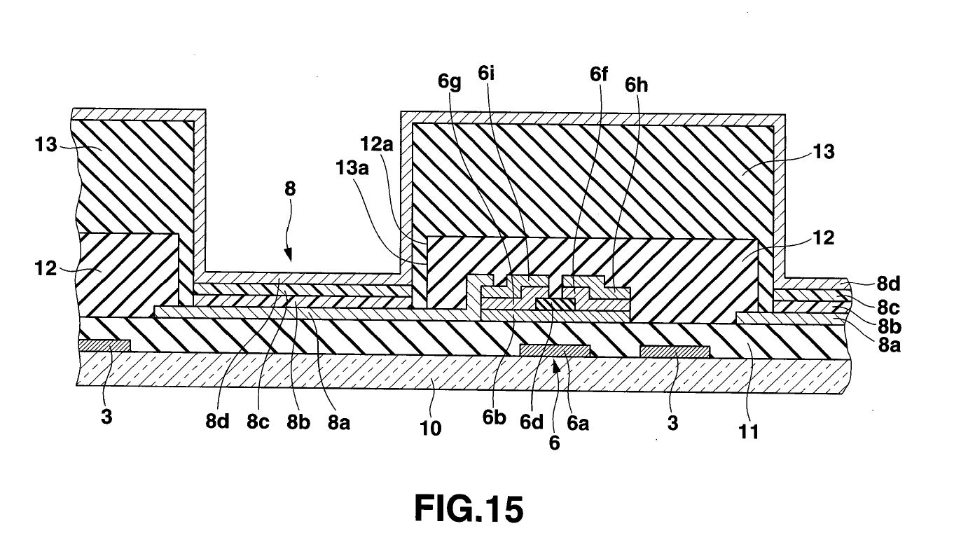

FIG. 15 is a sectional view taken from the line XV-XV in FIG. 14 and viewed along the arrows in FIG. 14.

As shown in FIG. 14, the switching transistor 5 and the driving transistor 6 are arranged along the signal line 3. The capacitor 7 is arranged in the vicinity of the switching transistor 5, and the EL element 8 is arranged in the vicinity of the driving transistor 6.

The switching transistor 5, the driving transistor 6, the capacitor 7, and the EL element 8 are arranged between the scanning line 2 and the voltage supply line 4.

As shown in FIG. 15, the driving transistor 6 includes a gate electrode 6a, a semiconductor film 6b, a cannel protection film 6d, impurity semiconductor films 6f and 6g, a drain electrode 6h, and a source electrode 6i.

The switching transistor 5 includes a gate electrode 5a, a semiconductor film, a cannel protection film, impurity semiconductor films, a drain electrode 5h, and a source electrode 5i. The switching transistor 5 is a thin film transistor similar to the driving transistor 6 which is described in details below, and hence the detailed description of the switching transistor 5 is omitted.

As shown in FIGs. 14 and 15, an interlayer insulating film 11 which becomes a gate insulating film is deposited all over a surface of the substrate 10, and an interlayer insulating film 12 is deposited on the interlayer insulating film 11.

The signal line 3 is formed between the interlayer insulating film 11 and the substrate 10. The scanning line 2 and the voltage supply line 4 are formed between the interlayer insulating film 11 and the interlayer insulating film 12.

The gate electrode 6a is formed between the substrate 10 and the interlayer insulating film 11.

The gate electrode 6a is composed of a Cr film, an Al film, a Cr/Al laminated film, an AlTi alloy film, or an AlTiNd alloy film, for example.

The interlayer insulating film 11 is deposited on the gate electrode 6a, and the gate electrode 6a is covered with the interlayer insulating film 11.

The interlayer insulating film 11 is composed of a silicon nitride or polycrystalline silicon, for example. The intrinsic semiconductor film. 6b is formed at a position on the interlayer insulating film 11, the position corresponding to the gate electrode 6a. The semiconductor film 6b and the gate electrode 6a face each other across the interlayer insulating film 11.

The semiconductor film 6b is composed of amorphous silicone or polycrystalline silicon, for example. A cannel is formed in the semiconductor film 6b.

On the center part of the semiconductor film 6b, the insulating channel protection film 6d is formed. The cannel protection film 6d is composed of a silicone nitride or a silicone oxide, for example.

On one end of the semiconductor film 6b, the impurity semiconductor film 6f is formed such that apart of the impurity semiconductor film 6f is superposed on the channel protection film 6d. On the other end of the semiconductor film 6b, the impurity semiconductor film 6g is formed such that a part of the impurity semiconductor film 6g is superposed on the channel protection film 6d.

The impurity semiconductor films 6f and 6g are formed at the one end of the semiconductor film 6b and the other end thereof, respectively, such that the impurity semiconductor films 6f and 6g are separated from each other. The impurity semiconductor films 6f and 6g are n-type semiconductors, but not limited thereto. For example, the impurity semiconductor films 6f and 6g may be p-type semiconductors.

The drain electrode 6h and the source electrode 6i are formed on the impurity semiconductor films 6f and 6g, respectively. The drain electrode 6h and the source electrode 6i are composed of, for example, Cr films, Al films, Cr/Al laminated films, AlTi alloy films, or AlTiNd alloy films, respectively.

The interlayer insulating film 12 which becomes a protection film is deposited on the channel protection film 6d, the drain electrode 6h, and the source electrode 6i. The channel protection film 6d, the drain electrode 6h, and the source electrode 6i are covered with the interlayer insulating film 12.

The driving transistor 6 is covered with the interlayer insulating film 12. The interlayer insulating film 12 is composed of a silicone nitride or a silicone oxide whose thickness is between 100 nm and 200 nm, for example.

The capacitor 7 is disposed between and connected to the gate electrode 6a and the source electrode 6i of the driving transistor 6.

As shown in FIG. 14, one of the two electrodes of the capacitor 7, an electrode 7a, is formed between the substrate 10 and the interlayer insulating film 11. The other of the two electrodes of the capacitor 7, an electrode 7b, is formed between the interlayer insulating film 11 and the interlayer insulating film 12. The electrodes 7a and 7b face each other across the interlayer insulating film 11, which is a dielectric substance. Thereby, the capacitor 7 is structured.

The signal line 3, the electrode 7a of the capacitor 7, the gate electrode 5a of the switching transistor 5, and the gate electrode 6a of the driving transistor 6 are formed all together by deforming an electronic conducting film, which is deposited all over the surface of the substrate 10, by photolithography, etching, and the like.

The scanning line 2, the voltage supply line 4, the electrode 7b of the capacitor 7, the drain electrode 5h and the source electrode 5i of the switching transistor 5, and the drain electrode 6h and the source electrode 6i of the driving transistor 6 are formed all together by deforming an electronic conducting film, which is deposited all over a surface of the interlayer insulating film 11, by photolithography, etching, and the like.

In the interlayer insulating film 11, a contact hole 11a is formed in a region where the gate electrode 5a and the scanning line 2 overlap with each other, a contact hole 11b is formed in a region where the drain electrode 5h and the signal line 3 overlap with each other, and a contact hole 11c is formed in a region where the gate electrode 6a and the source electrode 5i overlap with each other. Contact plugs 20a to 20c are implanted in the contact holes 11a to 11c, respectively.

The gate electrode 5a of the switching transistor 5 and the scanning line 2 are electrically connected with each other by the contact plug 20a. The drain electrode 5h of the switching transistor 5 and the signal line 3 are electrically connected with each other by the contact plug 20b. The source electrode 5i of the switching transistor 5 and the electrode 7a of the capacitor 7, and also the source electrode 5i of the switching transistor 5 and the gate electrode 6a of the driving transistor 6 are electrically connected with each other by the contact plug 20c. The scanning line 2 and the gate electrode 5a, the drain electrode 5h and the signal line 3, and the source electrode 5i and the gate electrode 6a may directly contact with each other, respectively, not via the respective contact plugs 20a to 20c.

The gate electrode 6a of the driving transistor 6 is connected to the electrode 7a of the capacitor 7 so as to be a single unit. The drain electrode 6h of the driving transistor 6 is connected to the voltage supply line 4 so as to be a single unit. The source electrode 6i of the driving transistor 6 is connected to the electrode 7b of the capacitor 7 so as to be a single unit.

A plurality of pixel electrodes 8a is provided on the substrate 10 with the interlayer insulating film 11 in between, and each of the pixel electrodes 8a is formed individually in each pixel P. The pixel electrode 8a is a transparent electrode, and is composed of tin-doped indium oxide (ITO), zinc-doped indium oxide, indium oxide (In₂O₃), tin oxide (SnO₂), zinc oxide (ZnO), or cadmium-tin oxide (CTO), for example. A part of the pixel electrode 8a is superposed on the source electrode 6i of the driving transistor 6, so that the pixel electrode 8a is connected to the source electrode 6i.

As shown in FIGS. 14 and 15, the interlayer insulating film 12 is formed so as to cover the scanning line 2, the signal line 3, the voltage supply line 4, the switching transistor 5, the driving transistor 6, the periphery part of the pixel electrode 8a, the electrode 7b of the capacitor 7, and the interlayer insulating film 11.

A plurality of opening sections 12a is formed in the interlayer insulating film 12 such that each of the opening sections 12a exposes the center part of each of the pixel electrodes 8a. The interlayer insulating film 12 is latticed viewed from above.

As shown in FIGS. 14 and 15, the banks 13 extend along the signal lines 3, respectively, and the banks 13 are parallel to each other. Hence, the banks 13 form stripes. Each of the banks 13 is formed such that the bank 13 covers the switching transistor 5 and the driving transistor 6 with the interlayer insulating film 12 in between.

Side walls 13a of the banks 13 are disposed inside the corresponding opening sections 12a, respectively. The center part of the pixel electrode 8a is exposed between the side walls 13a which face each other.

Each bank 13 functions as a partition wall, and prevents a liquid body from spreading from a pixel P into another pixel P which is next to the pixel P when a hole injection layer 8b or a light-emitting layer 8c is formed by a wet method. In the liquid body, a material making the hole injection layer 8b or the light-emitting layer 8c described below is dissolved or decomposed in a solvent.

As shown in FIGS. 14 and 15, the EL element 8 includes the pixel electrode 8a as a first electrode which acts as the anode, the hole injection layer 8b which is a compound film formed on the pixel electrode 8a, the light-emitting layer 8c which is a compound film formed on the hole injection layer 8b, and a counter electrode 8d as a second electrode formed on the light-emitting layer 8c. The counter electrode 8d is a single electrode shared with all the pixels P, and formed without being divided for all the pixels P.

The hole injection layer 8b is a carrier transfer layer composed of poly(ethylenedioxy)thiophene (PEDOT) which is an electro-conductive polymer and polystyrene sulfonate (PSS) which is a dopant, for example. The hole injection layer 8b injects electron holes from the pixel electrode 8a into the light-emitting layer 8c.

Each pixel P includes the light-emitting layer 8c having a material for emitting light of R, G, or B. The light-emitting layer 8c is a carrier transfer layer composed of a polyfluorene derivative light-emitting material or a polyphenylenevinylene derivative light-emitting material, for example. The light-emitting layer 8c emits light in response to recombination of electrons supplied from the counter electrode 8d and electron holes injected from the hole injection layer 8b. Therefore, the pixels P emitting the light of R, the pixels P emitting the light of G, the pixels P emitting the light of B are different from each other in the light-emitting material of the light-emitting layer 8c. The pattern of the pixels P emitting light of R, G, or B is a striped pattern in which the pixels P emitting light of the same color are arranged in a vertical direction.

The counter electrode 8d is composed of a material whose work function is lower than the work function of the pixel electrode 8a. The counter electrode 8d is a simple substance or an alloy composed of at least one of indium, magnesium, calcium, lithium, barium, and a rare-earth metal, for example.

The counter electrode 8d is shared with all the pixels P, so that the banks 13 thereof are covered with the counter electrode 8d and compound films such as the light-emitting layers 8c.

The hole injection layer 8b and the light-emitting layer 8c are severally provided between the banks 13 which are next to each other in the direction parallel to the banks 13, formed in the shape of a belt, and formed without being divided in the direction parallel to the banks 13. Therefore, the hole injection layer 8b and the light-emitting layer 8c are not partitioned by each pixel P in the direction parallel to the banks 13. That is, the hole injection layer 8b and the light-emitting layer 8c are shared with a plurality of pixel electrodes 8a arranged between the banks 13 which are next to each other. On the other hand, the hole injection layer 8b and the light-emitting layer 8c are partitioned into a plurality of hole injection layers 8b and a plurality of light-emitting layers 8c, respectively, by the banks 13 in the direction which is the orthogonal direction to the banks 13.

The hole injection layer 8b and the light-emitting layer 8c as carrier transfer layers are laminated on the pixel electrode 8a between the side walls 13a of the respective banks 13, the side walls 13a located in the opening section 12a. (See FIG. 15.) That is, when a voltage is applied between the pixel electrode 8a and the counter electrode 8d, the hole injection layer 8b and the light-emitting layer 8c function as carrier transfer layers at a part where the hole injection layer 8b and the light-emitting layer 8c overlap with the pixel electrode 8a, and light is emitted at the part of the light-emitting layer 8c.

More specifically, the side walls 13a of the banks 13 provided on the interlayer insulating film 12 are formed inside the opening section 12a.

A liquid body including a material making the hole injection layer 8b is applied onto the pixel electrode 8a sandwiched by the wide walls 13a and enclosed by the opening section 12a, and the substrate 10 including the liquid body is heated so as to dry the liquid body. A compound film which is formed by drying the liquid body becomes the hole injection layer 8b which is a first carrier transfer layer.

A liquid body including a material making the light-emitting layer 8c is applied onto the hole injection layer 8b sandwiched by the wide walls 13a and enclosed by the opening section 12a, and the substrate 10 including the liquid body is heated so as to dry the liquid body. A compound film which is formed by drying the liquid body becomes the light-emitting layer 8c which is a second carrier transfer layer.

The counter electrode 8d covers the light-emitting layer 8c and the banks 13. (See FIG. 15.)

On the EL panel 1, the pixel electrodes 8a, the substrate 10, and the interlayer insulating film 11 are transparent, and the light emitted from each of the light-emitting layers 8c radiates through each of the pixel electrodes 8a, the substrate 10, and the interlayer insulating film 11. Therefore, the back surface of the substrate 10 functions as a display surface.

Not the back surface of the substrate 10 but the side of the EL panel 1 opposite to the substrate 10 may function as a display surface. In this case, the counter electrode 8d is a transparent electrode, and the pixel electrodes 8a are reflex electrodes, and the light emitted from each of the light-emitting layers 8c radiates through the counter electrode 8d.

The EL panel 1 emits light by being driven as follows.

A voltage is applied to the scanning lines 2 in order by the scanning driver in a state where the voltage at a prescribed level is applied to all the voltage supply lines 4. Thereby, the scanning lines 2 are selected in order.

When each scanning line 2 is selected, and a voltage at a level according to a gradation is applied to all the signal lines 3 by the data driver, the switching transistors 5 corresponding to the selected scanning line 2 are turned on. Accordingly, the voltage at the level according to the gradation is applied to the gate electrode 6a of each of the driving transistors 6 corresponding to each of the switching transistors 5.

According to the voltage applied to the gate electrode 6a of each of the driving transistors 6, the potential difference between the gate electrode 6a and the source electrode 6i of each of the driving transistors 6 is determined, and the intensity of the drain-source current of each of the driving transistors 6 is determined accordingly. Each of the EL elements 8 corresponding to each of the driving transistors 6 emits light whose brightness depends on the drain-source current thereof.

After that, when the selection of the scanning line 2 is released, the switching transistors 5 are turned off. Consequently, an electric charge according to the voltage applied to the gate electrode 6a of each of the driving transistors 6 is stored in each of the capacitors 7, and the potential difference between the gate electrode 6a and the source electrode 6i of each of the driving transistors 6 is maintained.

Accordingly, each of the driving transistors 6 keeps supplying the drain-source current whose current value is the same as the current value of the drain-source current of each of the driving transistors 6 which is supplied while the scanning line 2 is selected, and the brightness of each of the EL elements 8 is maintained.

### (6) Manufacturing Method of EL Panel by Using Application Device

Next, the manufacturing method of the EL panel by using the application device according to the embodiments of the present invention is described.

### (6-1) Process Prior to Using Application Device (Mainly Transistor Manufacturing Process)

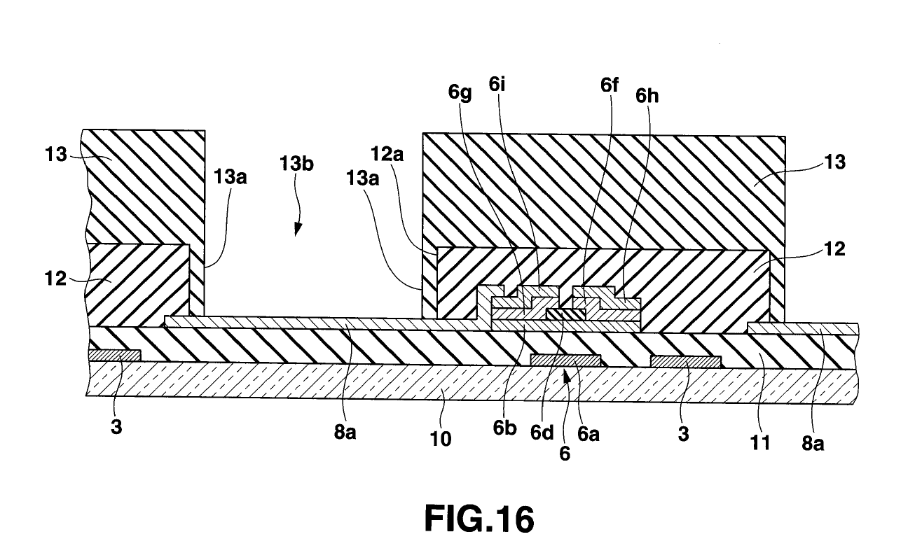

FIG. 16 is a sectional view showing a pixel electrode exposed between banks of the EL panel.

First, a gate metal layer is piled up on the substrate 121, which becomes the plurality of substrates 10, by spattering.

Then, the gate metal layer is patterned by photolithography, etching, and the like.

Accordingly, the signal line 3, the electrode 7a of the capacitor 7, the gate electrode 5a of the switching transistor 5, and the gate electrode 6a of the driving transistor 6, of each pixel P, are formed from the gate metal layer.

Next, the interlayer insulating film 11, which becomes a gate insulating film such as silicone nitride, is piled up by plasma CVD.

Then, a contact hole (not shown) which is open on an external connection terminal of each scanning line 2 (for example, an end of the scanning line 2) is formed in the interlayer insulating film 11. The contact hole is used for connecting the scanning line 2 with the scanning driver located at one side of the EL panel 1.

Next, a semiconductor layer such as amorphous silicon which becomes the semiconductor film 6b (5b) and an insulating layer such as silicon nitride which becomes the channel protection layer 6d (5d) are sequently piled up. Thereafter, the insulating layer is patterned by photolithography, etching, and the like. Consequently, the channel protection film. 6d (5d) is formed from the insulating layer.

After that, impurity layers which become the impurity semiconductor films 6f and 6g (5f and 5g) are piled up, and then the impurity layers and the semiconductor layer are sequently patterned by photolithography, etching, and the like. Consequently, the impurity semiconductor films 6f and 6g (5f and 5g) are formed from the impurity layers, and the semiconductor film 6b (5b) is formed from the semiconductor layer.

Then, the contact holes 11a to 11c are formed by photolithography and etching. Then, the contact plugs 20a to 20c are formed in the contact holes 11a to 11c, respectively. This step may be omitted.

A source-drain metal layer which forms the drain electrode 5h and the source electrode 5i of the switching transistor 5 and the drain electrode 6h and the source electrode 6i of the driving transistor 6 is piled up. Then, the source-drain metal layer is patterned. Consequently, the scanning line 2, the voltage supply line 4, the electrode 7b of the capacitor 7, the drain electrode 5h and the source electrode 5i of the switching transistor 5, and the drain electrode 6h and the source electrode 6i of the driving transistor 6 are formed from the source-drain metal layer.

The switching transistor 5 and the driving transistor 6 are formed as described above. Thereafter, an ITO film is piled up, and then patterned, so that the pixel electrode 8a is formed from the ITO film.

An insulating layer is deposited by vapor deposition such that the insulating layer covers the switching transistor 5, the driving transistor 6, and the like. Thereafter, the insulating layer is patterned by photolithography and etching.

Thereby, the plurality of opening sections 12a is formed in the insulating layer, and the interlayer insulating film 12 is formed accordingly. Each opening section 12a is formed above the center part of each pixel electrode 8a, and the center part of each pixel electrode 8a is exposed in each opening section 12a.

In addition to the plurality of opening sections 12a, a plurality of contact holes is formed in the interlayer insulating film 12. Each of the plurality of contact holes is open on the external connection terminal (not shown) of each of the scanning lines 2, on an external connection terminal of each of the signal lines 3 (for example, an end of each signal line 3), which is used for connecting each of the signal lines 3 with the data driver located at one side of the EL panel 1, or on an external connection terminal of each of the voltage supply lines 4 (for example, an end of each voltage supply line 4).

Next, the banks 13 which are parallel to each other and form stripes are formed by exposing photosensitive resin such as polyimide after piling up the photosensitive resin.

The banks 13 are formed such that the side walls 13a of the respective banks 13 are located on the corresponding pixel electrodes 8a. The banks 13 expose the above-mentioned contact holes (not shown) which are open on the external connection terminals.

By the process described above, each of the pixel electrodes 8a is exposed in each of the opening sections 12a of the interlayer insulating film 12 as shown in FIG. 16. A plurality of pixel electrodes 8a are exposed in each concave between the banks 13 which form stripes and are next to each other, and the pixel electrodes 8a in each concave are arranged parallel to the banks 13.

### (6-2) Application Process by Using Application Device

In order to apply a liquid which makes carrier transfer layers to the pixel electrodes 8a, each of which is located between the banks 13, four application devices 100 (100A) are prepared, for example.

The liquid tank 108 of a first application device 100 (100A) is filled with the liquid 120 which includes a material for the hole injection layer 8b.

The liquid tank 108 of a second application device 100 (100A) is filled with the liquid 120 which includes a material for the light-emitting layer 8c for emitting red light.

The liquid tank 108 of a third application device 100 (100A) is filled with the liquid 120 which includes a material for the light-emitting layer 8c for emitting green light.

The liquid tank 108 of a fourth application device 100 (100A) is filled with the liquid 120 which includes a material for the light-emitting layer 8c for emitting blue light.

In the following, a case where the application is performed by using the four application devices 100 (100A) in order is described, but this is not a limit. For example, the application may be performed by using one application device 100 (100A) by appropriately changing the liquid 120 with which the liquid tank 108 is filled.

Next, the substrate 121 on which the process prior to using the application device 100 (100A) is performed so that the steps until the step of forming the banks 13 are completed is disposed on the worktable 101 of the first application device 100 (100A). At the time, the substrate 121 is disposed on the worktable 101 such that the direction in which the banks 13 are extended is along the main-scanning direction.

Then, the control section 119 controls the massflow controller 109 to set the set flow rate.

Next, the supply device 116 and the carriage 105 are operated by the control section 119. Accordingly, the carriage 105 moves in the main-scanning direction from one end of the moving area thereof, and the liquid 120 is continuously discharged from the nozzle hole 168 of the nozzle head 106.

Then, the discharged liquid 120 is applied between the banks 13 which are next to each other. Consequently, a belt-shaped hole injection layer 8b is formed between the banks 13 which are next to each other, and the pixel electrodes 8a arranged between the banks 13 which are next to each other are covered with the hole injection layer 8b.

When the carriage 105 reaches the other end of the moving area thereof, the control section 119 stops the carriage 105.

Then, the control section 119 controls the moving device 102, so that the moving device 102 moves the worktable 101 and the substrate 121 through one pixel in the sub-scanning direction. The control section 119 stops the moving device 102 thereafter.

Next, the control section 119 operates the carriage 105. Accordingly, the carriage 105 moves the other way around in the main-scanning direction, and the liquid 120 is continuously discharged from the nozzle hole 168 of the nozzle head 106, so that a belt-shaped hole injection layer 8b is formed.

When the carriage 105 reaches the one end of the moving area thereof, the control section 119 stops the carriage 105. Then, the control section 119 controls the moving device 102, so that the moving device 102 moves the worktable 101 and the substrate 121 through one pixel in the sub-scanning direction. The control section 119 stops the moving device 102 thereafter.

After that, the control section 119 repeats controlling the carriage 105 and the moving device 102, and controlling the supply device 116 and the massflow controller 109.

Accordingly, the carriage 105 repeatedly moves from end to end of the moving area thereof while the liquid 120 is continuously discharged from the nozzle hole 168 of the nozzle head 106. Also, each time the carriage reaches an end (the one end or the other end) of the moving area thereof, the moving device 102 moves the worktable 101 and the substrate 121 through a prescribed distance in the sub-scanning direction.

As a result, the liquid 120 discharged from the nozzle head 106 is applied onto the substrate 121 in a pattern which looks as if a kudzu vine is folded. (See FIG. 8.)

In such a way described above, all the pixel electrodes 8a on the substrate 121 are covered with the hole injection layers 8b.

After drying the hole injection layers 8b, the substrate 121 is disposed on the worktable 101 of the second application device 100 (100A).

Belt-shaped light-emitting layers 8c for emitting red light are formed on the hole injection layers 8b by the second application device 100 (100A) performing the application in the way as described above.

The moving device 102 intermittently moves the worktable 101 and the substrate 121 in the sub-scanning direction. The moving distance is for three pixels.

As a result, a light-emitting layer 8c for emitting red light is formed in the main-scanning direction every three rows.

Next, the substrate 121 is disposed on the worktable 101 of the third application device 100 (100A).

Belt-shaped light-emitting layers 8c for emitting green light are formed on the hole injection layers 8b by the third application device 100 (100A) performing the application in the way as described above.

The moving device 102 intermittently moves the worktable 101 and the substrate 121 in the sub-scanning direction. The moving distance is for three pixels.

As a result, a light-emitting layer 8c for emitting green light is formed in the main-scanning direction every three rows.

Next, the substrate 121 is disposed on the worktable 101 of the fourth application device 100 (100A).

Belt-shaped light-emitting layers 8c for emitting blue light are formed on the hole injection layers 8b by the fourth application device 100 (100A) performing the application in the way as described above.

The moving device 102 intermittently moves the worktable 101 and the substrate 121 in the sub-scanning direction. The moving distance is for three pixels.

As a result, a light-emitting layer 8c for emitting blue light is formed in the main-scanning direction every three rows.

In such a way as described above, the light-emitting layers 8c are formed on all of the hole injection layers 8b.

(6-3) Process after Using Application Device

Next, the counter electrode 8d is deposited on the substrate 121 on which the light-emitting layers 8c are formed, and the light-emitting layers 8c and the banks 13 are covered with the counter electrode 8d.

The plurality of the EL panels 1 is completed by cutting and dividing the substrate 121 into the plurality of substrates 10.

As described above, the EL panel 1 manufactured by using the application device 100 (100A) is used as a display panel for various electronic devices, for example.

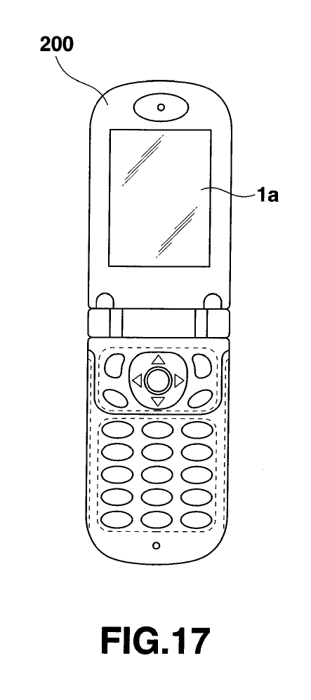

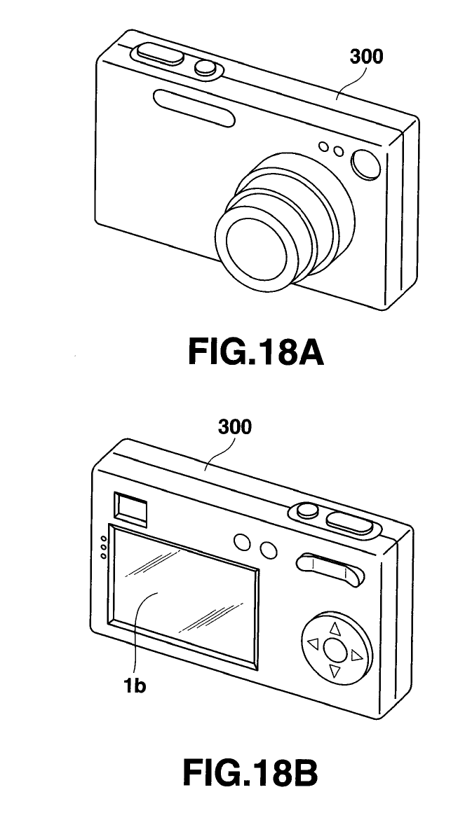

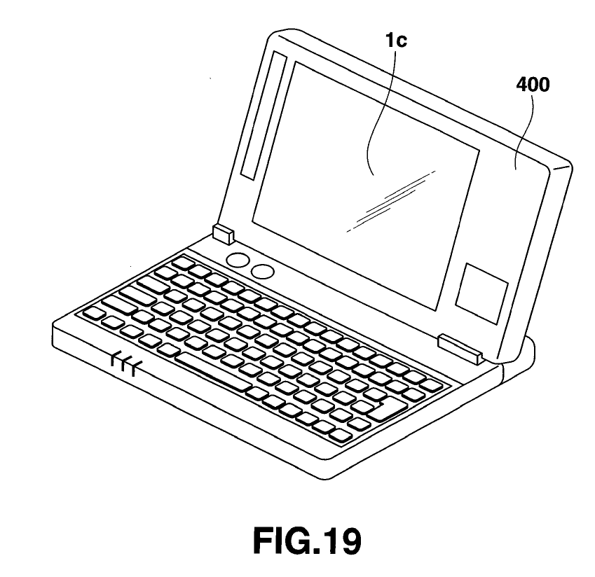

For example, the EL panel 1 can be used as a display panel 1a of a cell phone 200 shown in FIG. 17, a display panel 1b of a digital camera 300 shown in FIGS. 18A and 18B, and a display panel 1c of a personal computer 400 shown in FIG. 19.

The application of the present invention is not limited to the embodiments described above, and various modifications may be made without departing from the spirit or scope of the present invention.

Japanese Patent Application No. 2009-197696 filed on Aug. 28, 2009, the entire disclosure of which, including the description, claims, drawings, and abstract, is incorporated herein by reference in its entirety.

Although various representative embodiments are shown and described above, the present invention is not limited to the embodiments. The scope of the present invention is limited only by claims which follow.

What is claimed is:

1. An application device to apply a liquid on an application target region of a substrate, the application device comprising:
at least one discharge section including a nozzle hole which discharges the liquid;
a supporting table on which the substrate is disposed;
a carrying section to move the discharge section relative to the supporting table in a first direction;
a displacement amount detection section to detect a displacement amount of the discharge section in a second direction which crosses the first direction while the discharge section is moved relative to the supporting table in the first direction by the carrying section;
a position adjustment section to move one of the discharge section and the supporting table relative to the other in the second direction; and
a control section to control the position adjustment section so as to move the one of the discharge section and the supporting table in an offset direction which offsets the displacement amount while the discharge section is moved relative to the supporting table in the first direction by the carrying section.

2. The application device according to claim 1, wherein the substrate is disposed on the supporting table such that a longitudinal direction of the application target region is along the first direction, and
the control section controls the position adjustment section so as to move the one of the discharge section and the supporting table in the offset direction which offsets the displacement amount, when the liquid is applied to the application target region by disposing the substrate on the supporting table, disposing the discharge section above the application target region, and moving the discharge section along the application target region and relative to the supporting table in the first direction by the carrying section while discharging the liquid from the nozzle hole.

3. The application device according to claim 1, wherein the second direction is an orthogonal direction to the first direction in a parallel plane to a surface, on which the substrate is disposed, of the supporting table.

4. The application device according to claim 1, wherein the displacement amount detection section detects an average value of a plurality of displacement of the discharge section in the second direction as the displacement amount, the plurality of displacement which is obtained by reciprocating the discharge section relative to the supporting table in the first direction multiple times by the carrying section.

5. The application device according to claim 1, wherein the displacement amount detection section detects vibration intensity corresponding to the displacement amount of the discharge section, and
the control section controls the position adjustment section based on the detected vibration intensity such that the discharge section makes a movement in the offset direction of the second direction relative to the supporting table, the movement whose magnitude is same as a magnitude of the detected vibration intensity and whose phase is opposite to a phase of the detected vibration intensity, or such that the supporting table makes a movement in the offset direction of the second direction relative to the discharge section, the movement whose magnitude and whose phase are same as a magnitude and a phase of the detected vibration intensity.

6. The application device according to claim 1, wherein the carrying section includes:
a rail provided along the first direction; and
a carriage provided to be movable in the first direction along the rail, and
the discharge section is provided with the carriage through the position adjustment section.

7. The application device according to claim 6, wherein the displacement amount detection section is provided with one of the discharge section and the carriage.

8. The application device according to claim 6 further comprising:
an image pickup section to pick up an image of the application target region of the substrate, the image pickup section being provided with one of the discharge section and the carriage, wherein
the control section controls the position adjustment section based on the image of the application target region picked up by the image pickup section so as to move the one of the discharge section and the supporting table such that the nozzle hole of the discharge section is brought close to a center position of a width of the application target region, the width being along the second direction.

9. The application device according to claim 8, wherein when the discharge section is disposed above one area of the application target region, the image pickup section picks up an image of another area of the application target region to which the liquid is not applied.

10. The application device according to claim 8 further comprising:
a moving device to move the supporting table relative to the discharge section in the second direction which is an orthogonal direction to the first direction in a parallel plane to a surface, on which the substrate is disposed, of the supporting table, wherein
the substrate includes a plurality of the application target regions, and
when the discharge section is disposed above one of the plurality of application target regions, the image pickup section picks up an image of another one of the plurality of application target regions to which the liquid is not applied, and which is separated from the one of the plurality of application target regions.

11. The application device according to claim 8, wherein, based on the image of the application target region picked up by the image pickup section, the control section extracts a distortion amount of at least one reference line in the second direction, the reference line which extends in the first direction and is along one of two verges of the application target region in the second direction, and based on the extracted distortion amount of the reference line, the control section controls the position adjustment section so as to move the one of the discharge section and the supporting table.

12. The application device according to claim 11, wherein the control section extracts two of the reference line which are along the two verges of the application target region in the second direction, respectively; extracts a center line based on the two reference lines, the center line which extends in the first direction and is along a middle of a width of the application target region, the width being along the second direction; and controls the position adjustment section based on the extracted center line so as to move the one of the discharge section and the supporting table in the second direction such that the nozzle hole of the discharge section is brought close to the center line.

13. A driving method of an application device to apply a liquid on an application target region of a substrate, the driving method comprising the steps of:
disposing the substrate on a supporting table;
moving at least one discharge section relative to the supporting table in a first direction, the discharge section including a nozzle hole which discharges the liquid;
detecting a displacement amount of the discharge section in a second direction which crosses the first direction while moving the discharge section relative to the supporting table in the first direction; and
moving one of the discharge section and the supporting table relative to the other in an offset direction which offsets the displacement amount while moving the discharge section relative to the supporting table in the first direction.

14. The driving method of the application device according to claim 13 further comprising the step of:
discharging the liquid from the nozzle hole of the discharge section, wherein
the substrate is disposed on the supporting table such that a longitudinal direction of the application target region is along the first direction,
the second direction is an orthogonal direction to the first direction in a parallel plane to a surface, on which the substrate is disposed, of the supporting table,
the liquid is applied to the application target region of the substrate by disposing the discharge section above the application target region, and moving the discharge section along the application target region and relative to the supporting table in the first direction while discharging the liquid from the nozzle hole, and
the step of moving one of the discharge section and the supporting table in an offset direction includes the step of moving the one of the discharge section and the supporting table in the offset direction which offsets the displacement amount while moving the discharge section relative to the supporting table in the first direction in the step of applying the liquid.

15. The driving method of the application device according to claim 13, wherein the step of detecting a displacement amount includes the step of detecting an average value of a plurality of displacement of the discharge section in the second direction as the displacement amount, the plurality of displacement which is obtained by reciprocating the discharge section relative to the supporting table multiple times in the first direction.

16. The driving method of the application device according to claim 13 further comprising the steps of:
picking up an image of the application target region of the substrate; and
moving the one of the discharge section and the supporting table in the second direction based on the picked-up image of the application target region such that the nozzle hole of the discharge section is brought close to a center position of a width of the application target region, the width being along the second direction.

17. The driving method of the application device according to claim 16, wherein when the discharge section is disposed above one area of the application target region, an image of another area of the application target region where the discharge section is moved thereafter and to which the liquid is not applied, is picked up.

18. The driving method of the application device according to claim 16, wherein
the substrate includes a plurality of the application target regions,
the step of moving the discharge section includes the step of moving the supporting table relative to the discharge section in the second direction which is an orthogonal direction to the first direction in a parallel plane to a surface, on which the substrate is disposed, of the supporting table, and
when the discharge section is disposed above one of the plurality of application target regions, an image of another one of the plurality of application target regions, the another one which is separated from the one of the application target regions, to which the discharge section is moved thereafter, and to which the liquid is not applied, is picked up.

19. The driving method of the application device according to claim 16, wherein the step of moving one of the discharge section and the supporting table in the second direction based on the picked-up image includes the steps of:
extracting at least one reference line which extends in the first direction and is along one of two verges of the application target region in the second direction; and
moving the one of the discharge section and the supporting table in the second direction based on a distortion amount of the reference line in the second direction.

20. The driving method of the application device according to claim 19, wherein the step of moving one of the discharge section and the supporting table in the second direction based on the picked-up image includes the steps of:
extracting two of the reference line which are along the two verges of the application target region in the second direction, respectively, and extracting a center line based the two reference lines, the center line which extends in the first direction and is along a middle of a width of the application target region, the width being along the second direction; and
moving the one of the discharge section and the supporting table in the second direction such that the nozzle hole of the discharge section is brought to a position along the center line.
